(19) United States
(12) Patent Application Publication
(10) Pub. No.: US 2020/0079972 A1
(43) Pub. Date: Mar. 12, 2020

(54) AUTOMOTIVE PARTS AND PROCESSES FOR PRODUCING THE SAME

(71) Applicants: DAICEL CORPORATION, Osaka (JP); TOYOTA JIDOSHA KABUSHIKI KAISHA, Toyota-shi (JP)

(72) Inventors: Yutaka Isobe, Tokyo (JP); Naoya Ikeda, Toyota-shi (JP); Ippei Fukutomi, Toyota-shi (JP); Kazuyoshi Manabe, Toyota-shi (JP)

(73) Assignees: DAICEL CORPORATION, Osaka (JP); TOYOTA JIDOSHA KABUSHIKI KAISHA, Toyota-shi (JP)

(21) Appl. No.: 16/510,437

(22) Filed: Jul. 12, 2019

(30) Foreign Application Priority Data
Sep. 11, 2018 (JP) 2018-169448

(51) Int. Cl. C09D 163/10; C09D 7/47; C09D 7/65

(52) U.S. Cl. CPC C09D 163/10; C09D 7/65; C09D 7/47

(57) ABSTRACT

An automotive part includes a substrate and a cured layer bonded to the substrate, and the cured layer comprises a cured product of a curable composition containing: (A) an epoxy compound containing (A1) a first epoxy compound having at least two alicyclic epoxy groups and (A2) a second epoxy compound represented by the following formula (3):

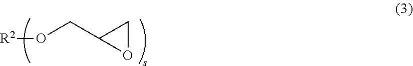

wherein s denotes an integer of not less than 2, R² represents a s-valent straight-chain or branched-chain saturated aliphatic hydrocarbon group, or a s-valent group in which two or more straight-chain or branched-chain saturated aliphatic hydrocarbon groups are coupled through ether bond(s); and (C) a leveling agent.

### TECHNICAL FIELD

The present invention relates to an automotive part having an excellent adhesion between a substrate and a cured layer (a cured product or a coating layer) and a process for producing the same.

### BACKGROUND ART

Various shaped products including automotive parts, for example, sliding members, have various coating layers on surfaces thereof in order to impart coloring, change of texture, surface protection, and other functions and/or design to the surfaces. Materials for forming such coating layers include many materials according to the purposes, for example, organic materials such as resins, and inorganic materials such as metals and carbon materials. The organic materials are widely used in view of the formation of the coating layers at a high productivity by a simple method such as coating without using deposition or other methods.

For example, Japanese Patent Application Laid-Open Publication No. 2016-121314 (JP 2016-121314 A, Patent Document 1) discloses an anti-wear agent containing an alicyclic difunctional epoxy and a polymerization initiator. The document discloses that the anti-wear agent can form a coating layer having anti-wear properties in sliding members of internal combustion engines of ships and vehicles. According to Examples of this document, 3,4,3′,4′-diepoxybicyclohexyl, a silicone-series leveling agent, and a polymerization initiator (a photoacid generator) are mixed to prepare a hardcoat solution (an anti-wear agent), and the hardcoat solution is used to form a hardcoat layer on an aluminum plate with a primer layer therebetween.

WO 2017/081963 (Patent Document 2) discloses, as a surface treatment kit for treating a surface of a shaped product made of a metal, a surface treatment kit that contains (A) a curable liquid composition containing a specific difunctional alicyclic epoxy compound and (B) a liquid composition containing a polyamideimide resin. According to Examples of this document, the liquid composition (B) is applied on an aluminum plate to form a primer layer, and the curable liquid composition (A) containing a specific difunctional alicyclic epoxy compound, a curing agent, and a leveling agent is applied on the primer layer to form a top coat layer.

The coating layers described in these documents are low in adhesion to substrates, probably because the coating layers are formed of alicyclic epoxy compounds. It is thus necessary to form a primer layer, and there is a limit to the improvement in productivity.

### CITATION LIST

### Patent Literature

Patent Document 1: JP 2016-121314 A (Claims, [0002], [0007], and Examples)

Patent Document 2: WO 2017/081963 (Claims and Examples)

### SUMMARY OF INVENTION

### Technical Problem

It is therefore an object of the present invention to provide an automotive part having an excellent adhesion between a substrate (for example, a shaped product of an inorganic material such as a metal) and a cured layer (a cured product or a coating layer) without formation of a primer layer, and a process for producing the automotive part.

Another object of the present invention is to provide an automotive part having a cured layer with an excellent appearance and a smooth surface, and a process for producing the automotive part.

It is still another object of the present invention to provide an automotive part having a cured layer with excellent sliding properties (for example, surface smoothness, hardness or rigidity, and abrasion resistance), and a process for producing the automotive part.

### Solution to Problem

The inventors of the present invention made intensive studies to achieve the above objects and finally found that a cured layer of a curable composition containing a polyfunctional alicyclic epoxy compound, a specific polyfunctional glycidyl ether-type epoxy compound, and a leveling agent has an improved adhesion to a substrate without interposition of a primer layer. The present invention was accomplished based on the above findings.

That is, an aspect of the present invention provides an automotive part containing a substrate and a cured layer bonded to the substrate. The cured layer includes a cured product of a curable composition containing (A) an epoxy compound containing (A1) a first epoxy compound having at least two alicyclic epoxy groups and (A2) a second epoxy compound represented by the following formula (3):

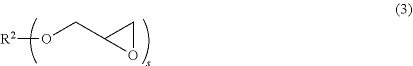

wherein s denotes an integer of not less than 2, R² represents a s-valent straight-chain or branched-chain saturated aliphatic hydrocarbon group, or a s-valent group in which two or more straight-chain or branched-chain saturated aliphatic hydrocarbon groups are coupled through ether bond(s); and

(C) a leveling agent.

The first epoxy compound (A1) may contain a compound represented by the following formula (2):

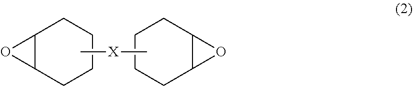

wherein X represents a single bond or a linkage group, and the cyclohexene oxide groups may have a substituent.

The first epoxy compound (A1) may contain a compound represented by the formula (2) in which X is a single bond. The second epoxy compound (A2) may contain a compound represented by the formula (3) in which the group R² has a total number of carbon atoms of 2 to 15 and the number s is 2 to 4.

The weight ratio of the first epoxy compound (A1) relative to the second epoxy compound (A2) may be, for example, about 30/70 to 90/10 in the former/the latter.

The curable composition may further contain (B) a polymerizable compound (a hydroxy-group-containing polymerizable compound) having a hydroxy group and at least one polymerizable group selected from the group consisting of a vinyl ether group, an epoxy group, and an oxetane-ring-containing group. The hydroxy-group-containing polymerizable compound (B) may contain (b1) a compound having one vinyl ether group and one hydroxy group and (b3) a compound having one oxetane-ring-containing group and one hydroxy group. The weight ratio of the epoxy compound (A) relative to the hydroxy-group-containing polymerizable compound (B) may be, for example, about 10/90 to 95/5 in the former/the latter. The weight ratio of the compound (b3) relative to the compound (b1) may be, for example, about 10/90 to 95/5 in the compound (b3)/the compound (b1).

The leveling agent (C) may contain a hydroxy-group-containing leveling agent. The leveling agent (C) may contain a silicone-series hydroxy-group-containing leveling agent. The leveling agent (C) may contain a leveling agent having a hydroxyl value of 15 to 100 mgKOH/g.

The curable composition may further contain (D) a solvent at least containing (D1) a high-boiling solvent.

The high-boiling solvent (D1) may contain at least one high-boiling solvent selected from the group consisting of an aromatic hydrocarbon compound having an alkyl group and a cyclic ester compound.

The substrate may be a shaped product of an inorganic material. The inorganic material may include a metal material. The substrate may have a surface having an area with a maximum height roughness Rz of 1 to 50 μm, and the area may be bonded to the cured layer. The automotive part may be a sliding member.

Another aspect of the present invention provides a process for producing the automotive part, the process including: applying the curable composition to the substrate and curing the applied curable composition. The production process may further include, prior to the applying step, treating a surface of the substrate to form the surface having a maximum height roughness Rz of 1 to 50 μm. The surface treatment may be a blast treatment.

As used herein, the term “alicyclic epoxy group” means a group at least having a skeleton in which an aliphatic ring (for example, a cycloalkane ring such as cyclohexane ring) and an oxirane ring (or an epoxide) are condensed to share two adjacent carbon atoms.

### Advantageous Effects of Invention

In the automotive part, the cured layer (or coating layer) is formed of the cured product of the curable composition containing the specific epoxy compound and the leveling agent and is thus bondable to the substrate (for example, a shaped product of an inorganic material including a metal material) with a high adhesion without formation of a primer layer. Such a coating layer has an excellent appearance and an excellent surface smoothness. The coating layer is high in surface smoothness, hardness or rigidity, abrasion resistance, and other properties and has excellent sliding properties.

### BRIEF DESCRIPTION OF DRAWINGS

FIG. 1 is a schematic view of an example of a cam nose portion having a cured layer.

FIG. 2 is a cross-sectional view taken along line II-II of the cam nose portion in FIG. 1.

FIG. 3 is a schematic view of an example of a piston skirt portion having a cured layer.

FIG. 4 is a cross-sectional view taken along line IV-IV of the piston skirt portion in FIG. 3.

FIG. 5A is a schematic view of an example of a roller rocker portion having a cured layer.

FIG. 5B is a side view of FIG. 5A.

FIG. 6A is a schematic view of an example of a chain damper portion having a cured layer.

FIG. 6B is a partial cross-sectional view of FIG. 6A.

FIG. 7 is a schematic view of an example of a valve lifter portion having a cured layer.

FIG. 8 is a schematic view of an example of a cam and crank bearing portion having a cured layer.

### DESCRIPTION OF EMBODIMENTS

An automotive part according to an embodiment of the present invention includes a substrate and a cured layer (or a coating layer) containing a cured product of a specific curable composition. The curable composition at least contains (A) a specific epoxy compound (or a first polymerizable compound) and (C) a leveling agent. If necessary, the curable composition may contain (B) a specific hydroxy-group-containing polymerizable compound (or a second polymerizable compound) or other compounds.

[(A) Epoxy Compound (or First Polymerizable Compound)]

In an embodiment of the present invention, the curable composition may contain two or more kinds of compounds, each having at least one epoxy group per molecule and having no hydroxy group. As used herein, such a compound may be referred to as “(A) epoxy compound”. The epoxy compound (A) may have a cationic polymerizable group (for example, a vinyl ether group, an oxetane-ring-containing group) other than the epoxy group.

The epoxy group may include an alicyclic epoxy group (for example, a cyclohexene oxide group represented by the following formula (1-1)) composed of two adjacent carbon atoms of an alicyclic hydrocarbon ring (for example, a 3- to 8-membered alicyclic hydrocarbon ring) and an oxygen atom, and an ethylene oxide group represented by the following formula (1-2):

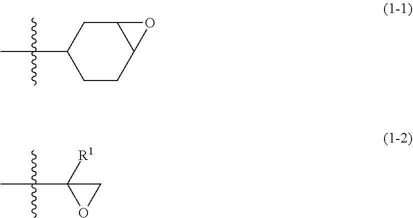

wherein R¹ represents a hydrogen atom or a C₁₋₃alkyl group.

Among the epoxy compounds (A), a compound having two or more epoxy groups per molecule is preferred in view of excellent hardenability. Particularly preferred is at least one selected from the group consisting of a compound having two or more alicyclic epoxy groups per molecule (such a compound may be referred to as “(A1) first epoxy compound”), a compound having two or more ethylene oxide groups per molecule (provided that, a compound having two or more alicyclic epoxy groups per molecule is excluded), and a compound having one alicyclic epoxy group and one ethylene oxide group per molecule.

(Compound Having Two or More Alicyclic Epoxy Groups Per Molecule)

The compound having two or more alicyclic epoxy groups per molecule (the first epoxy compound) (A1) may have one or a plurality of ethylene oxide groups. From the point of view of the formation of a cured product being high in hardness or rigidity, sliding properties, and heat resistance, for example, preferred is a compound represented by the following formula (2):

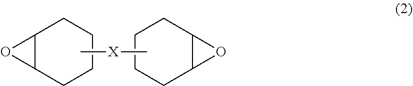

wherein X represents a single bond or a linkage group, and the cyclohexene oxide groups may have a substituent.

The linkage group may include, for example, a divalent hydrocarbon group, an alkenylene group in which some or all carbon-carbon double bonds have been epoxidized, a carbonyl group (—CO—), an ether bond (—O—), an ester bond (—COO—), a carbonate group (—O—CO—O—), an amide group (—CONH—), and a group having a plurality of these linkage groups linked.

The divalent hydrocarbon group may include, for example, a straight-chain or branched-chain C₁₋₁₈alkylene group, and a divalent C₃₋₁₈alicyclic hydrocarbon group. Examples of the straight-chain or branched-chain C₁₋₁₈alkylene group may include methylene group, methylmethylene group, dimethylmethylene group, ethylene group, propylene group, and trimethylene group. The divalent C₃₋₁₈alicyclic hydrocarbon group may include, for example, a cycloalkylene group (including a cycloalkylidene group) such as 1,2-cyclopentylene group, 1,3-cyclopentylene group, cyclopentylidene group, 1,2-cyclohexylene group, 1,3-cyclohexylene group, 1,4-cyclohexylene group, or cyclohexylidene group.

In the alkenylene group in which some or all carbon-carbon double bonds have been epoxidized (such a group may be referred to as “epoxidized alkenylene group”), examples of the alkenylene group may include a straight-chain or branched-chain C₂₋₈alkenylene group such as vinylene group, propenylene group, 1-butenylene group, 2-butenylene group, butadienylene group, pentenylene group, hexenylene group, heptenylene group, or octenylene group. In particular, as the epoxidized alkenylene group, an alkenylene group in which all carbon-carbon double bonds have been epoxidized is preferred, and a C₂₋₄alkenylene group in which all carbon-carbon double bonds have been epoxidized is more preferred.

Among them, preferred as X are a single bond, a carbonyloxymethylene group, or others. In view of excellent sliding properties (surface smoothness) and rigidity, a single bond is particularly preferred.

The cyclohexene oxide groups in the formula (2) may have a substituent. The substituent may include, for example, a halogen atom, a C₁₋₁₀alkyl group, a C₁₋₁₀alkoxy group, a C₂₋₁₀alkenyloxy group, a C₆₋₁₄aryloxy group, a C₇₋₁₈aralkyloxy group, a C₁₋₁₀acyloxy group, a C₁₋₁₀alkoxycarbonyl group, a C₆₋₁₄aryloxycarbonyl group, a C₇₋₁₈aralkyloxycarbonyl group, an epoxy-group-containing group, an oxetane-ring-containing group, a C₁₋₁₀acyl group, an isocyanate group, a sulfo group, a carbamoyl group, and an oxo group. The number of substituents may be one or more. In terms of rigidity, it is preferred that the cyclohexene oxide groups have no substituent.

Representative examples of the compound represented by the formula (2) may include (3,4,3′,4′-diepoxy)bicyclohexyl, bis(3,4-epoxycyclohexylmethyl) ether, 1,2-epoxy-1,2-bis(3,4-epoxycyclohexan-1-yl)ethane, 2,2-bis(3,4-epoxycyclohexan-1-yl)propane, 1,2-bis(3,4-epoxycyclohexan-1-yl)ethane, and compounds represented by the following formulae (2-1) to (2-8):

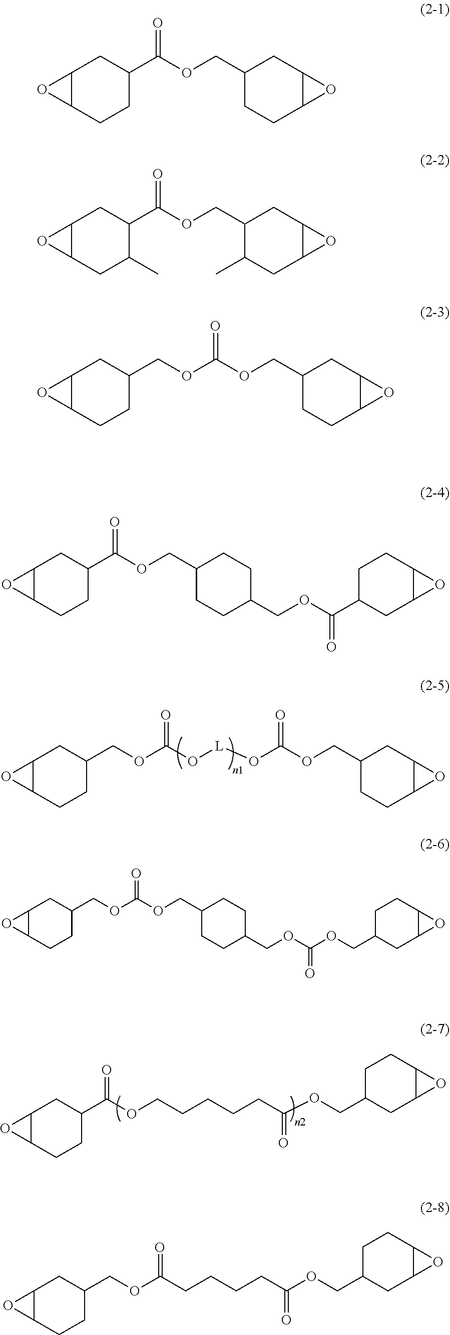

wherein L represents a C₁₋₈alkylene group (for example, a straight-chain or branched-chain C₁₋₃alkylene group such as methylene group, ethylene group, propylene group, or isopropylene group), n1 and n2 each represent an integer of 1 to 30.

The compound having two or more alicyclic epoxy groups per molecule further includes compounds represented by the following formulae (2-9) and (2-10):

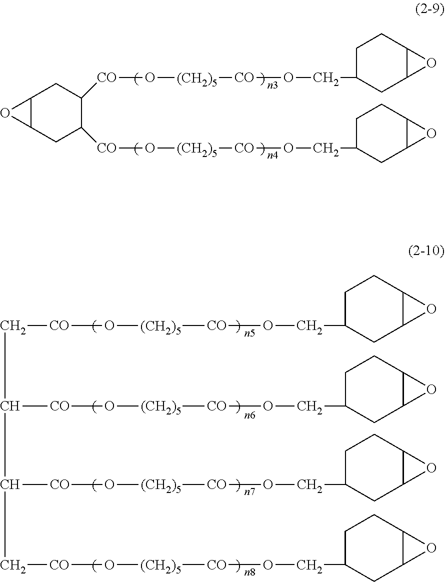

wherein n3 to n8 are the same or different and each represent an integer of 1 to 30.

These compounds having two or more alicyclic epoxy groups per molecule (first epoxy compounds (A1)) may also be used alone or in combination. Among these first epoxy compounds (A1), the compound represented by the formula (2) is preferred. More preferred are, for example, 3,4,3′,4′-diepoxybicyclohexyl, in which X is a single bond, and 3,4-epoxycyclohexylmethyl(3,4-epoxy) cyclohexanecarboxylate, in which X is carbonyloxymethylene group (the compound represented by the formula (2-1)). In particular, 3,4,3′,4′-diepoxybicyclohexyl, in which X is a single bond, is preferred from the viewpoint that the hardness or rigidity, sliding properties, heat resistance, or others can be further improved.

(Compound Having Two or More Ethylene Oxide Groups Per Molecule)

Preferred as the compound having two or more ethylene oxide groups per molecule is a compound represented by the following formula (3) (such a compound may be referred to as “(A2) second epoxy compound”) in terms of easiness of the adhesion improvement. These second epoxy compounds (A2) may be used alone or in combination.

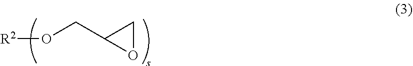

In the formula, s denotes an integer of not less than 2, R² represents a s-valent straight-chain or branched-chain saturated aliphatic hydrocarbon group, or a s-valent group in which two or more straight-chain or branched-chain saturated aliphatic hydrocarbon groups are coupled through ether bond(s).

The number (valence) s in the formula denotes an integer of not less than 2. For example, the number s is an integer of 2 to 6, preferably an integer of 2 to 4, more preferably an integer of 2 to 3, and particularly preferably 2.

As the s-valent straight-chain or branched-chain saturated aliphatic hydrocarbon group represented by R², a divalent straight-chain or branched-chain saturated aliphatic hydrocarbon group may include, for example, a straight-chain or branched-chain C₁₋₁₈alkylene group such as methylene group, methylmethylene group, dimethylmethylene group, ethylene group, propylene group, trimethylene group, or tetramethylene group (preferably a straight-chain or branched-chain C₁₋₁₀alkylene group, and particularly preferably a straight-chain or branched-chain C₃₋₆alkylene group). A tri- or more-valent straight-chain or branched-chain saturated aliphatic hydrocarbon group may include a group in which (s-2) hydrogen atoms have been removed from the structural formula of the divalent straight-chain or branched-chain saturated aliphatic hydrocarbon group.

The total number of carbon atoms in the group represented by R² is, for example, 1 to 20, preferably 2 to 15, particularly preferably 2 to 10, and most preferably 3 to 8.

Among the second epoxy compounds represented by the formula (3), preferred is at least one compound selected from the group consisting of compounds represented by the following formulae (3-1) to (3-5), trimethylolethane triglycidyl ether, pentaerythritol tetraglycidyl ether, glycerin triglycidyl ether, and dipentaerythritol hexaglycidyl ether. In particular, preferred is at least one compound selected from the group consisting of the compounds represented by the following formulae (3-1) to (3-5) in terms of a low viscosity and an excellent coatability. Most preferred is at least one compound selected from the group consisting of the compounds represented by the following formulae (3-1) to (3-4). In particular, from the viewpoint of adhesion, 1,4-butanediol diglycidyl ether represented by the following formula (3-2) is preferred.

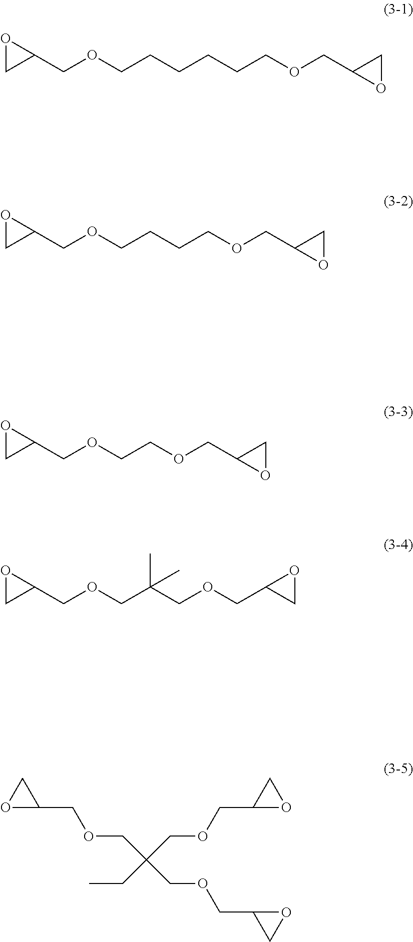 [SMILES: C(CCCOCC1CO1)CCOCC1CO1 ; C(CCOCC1CO1)COCC1CO1 ; C(COCC1CO1)OCC1CO1 ; CC(C)(COCC1CO1)COCC1CO1 ; CCC(COCC1CO1)(COCC1CO1)COCC1CO1]

The compound having two or more ethylene oxide groups per molecule may further include, for example, an alicyclic glycidyl ether such as hydrogenated bisphenol A-based diglycidyl ether, hydrogenated bisphenol F-based diglycidyl ether, hydrogenated biphenol-based diglycidyl ether, hydrogenated phenol novolac-based diglycidyl ether, or hydrogenated cresol novolac-based diglycidyl ether; an aromatic glycidyl ether such as bisphenol A-based diglycidyl ether, bisphenol F-based diglycidyl ether, biphenol-based diglycidyl ether, phenol novolac-based diglycidyl ether, or cresol novolac-based diglycidyl ether; and a compound represented by the following formula (4):

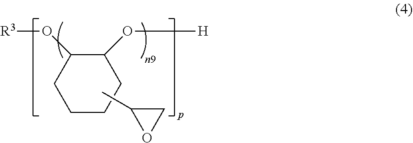

wherein p and n9 each represent a natural number, R³ represents a group (a p-valent organic group) in which p hydroxy groups (—OH) have been removed from a structural formula of a p-valent alcohol.

The p-valent alcohol [R³(OH)ₚ] may include a polyhydric alcohol (e.g., a polyhydric alcohol having 1 to 15 carbon atoms) such as 2,2-bis(hydroxymethyl)-1-butanol. The number p is preferably 1 to 6. The number n9 is preferably 1 to 30. When the number p is not less than 2, the numbers n9 in different square brackets may be the same or different. Specific examples of the compound represented by the formula (4) may include a 1,2-epoxy-4-(2-oxiranyl)cyclohexane adduct of 2,2-bis(hydroxymethyl)-1-butanol, for example, trade name “EHPE3150” (manufactured by Daicel Corporation).

The compound having one alicyclic epoxy group and one ethylene oxide group per molecule may include, for example, 1,2:8,9-diepoxylimonene.

In terms of obtaining a curable composition having a fast curability and a cured product having a high hardness, it is preferred that the epoxy compound (A) contain the compound having two or more alicyclic epoxy groups per molecule, particularly, the compound represented by the formula (2).

In an embodiment of the present invention, the curable composition at least contains the first epoxy compound having two or more alicyclic epoxy groups per molecule (A1) and the second epoxy compound represented by the formula (3) (A2) as the epoxy compound (A).

The proportion of the compound represented by the formula (2) in the first epoxy compound (A1) may be selected from a range of, for example, not less than 10% by weight (e.g., about 30 to 100% by weight). The first epoxy compound (A1) may contain the compound represented by the formula (2) in a proportion of, for example, not less than 50% by weight (e.g., about 60 to 99.9% by weight), preferably not less than 70% by weight (e.g., about 80 to 99% by weight), more preferably not less than 90% by weight (e.g., about 95 to 98% by weight), and particularly 100% by weight (may substantially contain the compound represented by the formula (2) alone).

The proportion of the total amount of the compounds represented by the formulae (3-1) to (3-5) (preferably the total amount of the compounds represented by the formulae (3-1) to (3-4), particularly the compound represented by the formula (3-2)) in the second epoxy compound (A2) may be selected from a range of, for example, not less than 10% by weight (e.g., about 30 to 100% by weight) and may be, for example, not less than 50% by weight (e.g., about 60 to 99.9% by weight), preferably not less than 70% by weight (e.g., about 80 to 99% by weight), more preferably not less than 90% by weight (e.g., about 95 to 98% by weight), and particularly 100% by weight. In a case where the proportion of the total amount of the compounds represented by the formulae (3-1) to (3-5) in the second epoxy compound is substantially 100% by weight, preferably the second epoxy compound may contain only the compounds represented by the formulae (3-1) to (3-4), particularly only the compound represented by the formula (3-2).

The proportion of the total amount of the first epoxy compound (A1) and the second epoxy compound (A2) in the epoxy compound (A) may be selected from a range of, for example, not less than 10% by weight (e.g., about 30 to 100% by weight). The epoxy compound (A) may contain the first epoxy compound (A1) and the second epoxy compound (A2) in a total proportion of, for example, not less than 50% by weight (e.g., about 60 to 99.9% by weight), preferably not less than 70% by weight (e.g., about 80 to 99% by weight), more preferably not less than 90% by weight (e.g., about 95 to 98% by weight), and particularly 100% by weight (may substantially contain only the first epoxy compound (A1) and the second epoxy compound (A2)).

The ratio of the first epoxy compound (A1) having two or more alicyclic epoxy groups per molecule [particularly the compound represented by the formula (2)] relative to the second epoxy compound (A2) represented by the formula (3) [for example, the compounds represented by the formulae (3-1) to (3-5), preferably the compounds represented by the formulae (3-1) to (3-4), particularly the compound represented by the formula (3-2)] may be selected from a range of, for example, about 1/99 to 99/1 (e.g., about 5/95 to 95/5) in the former/the latter (weight ratio) and may be, for example, about 10/90 to 93/7 (e.g., about 30/70 to 90/10), preferably about 40/60 to 85/15 (e.g., about 45/55 to 80/20), more preferably about 50/50 to 77/23 (e.g., about 55/45 to 75/25), and particularly about 60/40 to 72/28 (e.g., about 63/37 to 70/30). In a case where the ratio of the first epoxy compound (A1) is too low, the cured product may decrease in hardness or heat resistance. In a case where the ratio of the second epoxy compound (A2) is too low, the cured product may have an insufficiently improved adhesion.

The ratio of the epoxy compound (A) (the first polymerizable compound) relative to the total amount of compounds having polymerizable group(s) in the curable composition (the total amount of the first polymerizable compound and the after-mentioned second to third polymerizable compounds) may be selected from a range of, for example, about 1 to 100% by weight (e.g., about 10 to 95% by weight) and may be, for example, about 20 to 90% by weight (e.g., about 30 to 85% by weight), preferably about 40 to 80% by weight (e.g., about 45 to 75% by weight), and more preferably about 50 to 70% by weight (e.g., about 55 to 65% by weight).

[(B) Hydroxy-Group-Containing Polymerizable Compound (or Second Polymerizable Compound)]

In an embodiment of the present invention, the curable composition may optionally contain a compound having two or more kinds of functional groups per molecule as the hydroxy-group-containing polymerizable compound (B), specifically, a compound having at least one cationic polymerizable group selected from the group consisting of a vinyl ether group (or a vinyloxy group), an epoxy group and an oxetane-ring-containing group, and at least one hydroxy group per molecule. The oxetane-ring-containing group is any group at least having an oxetane ring skeleton and may include, for example, oxetanyl group; and an alkyloxetanyl group such as 3-ethyloxetan-3-yl group.

The hydroxy-group-containing polymerizable compound (B) may be used alone or in combination. A cured product or cured layer obtainable by curing a curable composition containing the hydroxy-group-containing polymerizable compound (B) has a highly crosslinked structure polymerized by the above-mentioned two or more kinds of functional groups and thus has a high hardness. In some embodiments, the cured product or cured layer improves in not only hardness or rigidity but also adhesion probably because the polymerizable group and the hydroxy group participate in the polymerization reaction (or crosslinking reaction).

Among the hydroxy-group-containing polymerizable compounds (B), (b) a compound having one hydroxy group and one cationic polymerizable group selected from the group consisting of a vinyl ether group, an epoxy group, and an oxetane-ring-containing group per molecule is preferred in terms of the obtainable cured product having a high hardness, a low cure shrinkage, and an improved adhesion.

The compound (b) includes the following three kinds of compounds. These compounds may be used alone or in combination.

b1: Compound having one vinyl ether group and one hydroxy group
b2: Compound having one epoxy group and one hydroxy group
b3: Compound having one oxetane-ring-containing group and one hydroxy group

The compound (b) is, for example, represented by the following formula (5):

HO—R^{a}—Y (5)

wherein R^{a} represents a divalent hydrocarbon group, a divalent heterocyclic group, or a divalent group having these groups coupled through single bond(s) or linkage group(s), and Y represents a cationic polymerizable group selected from the group consisting of a vinyl ether group (or a vinyloxy group), an epoxy group, and an oxetane-ring-containing group.

The divalent hydrocarbon group represented by R^{a} may include a divalent aliphatic hydrocarbon group, a divalent alicyclic hydrocarbon group, and a divalent aromatic hydrocarbon group.

Examples of the divalent aliphatic hydrocarbon group may include a straight-chain or branched-chain C₁₋₁₈alkylene group such as methylene group, methylmethylene group, dimethylmethylene group, ethylene group, propylene group, or trimethylene group; a straight-chain or branched-chain C₂₋₁₈alkenylene group such as vinylene group, 1-methylvinylene group, propenylene group, 1-butenylene group, 2-butenylene group, 1-pentenylene group, or 2-pentenylene group; and a straight-chain or branched-chain C₂₋₁₈alkynylene group such as ethynylene group, propynylene group, 3-methyl-1-propynylene group, butynylene group, or 1,3-butadiynylene group.

The alicyclic hydrocarbon ring of the divalent alicyclic hydrocarbon group may include a monocyclic hydrocarbon ring and a polycyclic hydrocarbon ring. The polycyclic hydrocarbon ring may include a spirohydrocarbon ring, a ring-aggregated hydrocarbon ring, a bridged cyclic hydrocarbon ring, a condensed cyclic hydrocarbon ring, and a bridged condensed cyclic hydrocarbon ring. The divalent alicyclic hydrocarbon group may include a group in which two hydrogen atoms have been removed from the structural formula of the above-mentioned alicyclic hydrocarbon group.

Examples of the monocyclic hydrocarbon ring may include a C₃₋₁₂cycloalkane ring such as cyclopropane, cyclobutane, cyclopentane, cyclohexane, cycloheptane, or cyclooctane; and a C₃₋₁₂cycloalkene ring such as cyclopentene or cyclohexene.

The spirohydrocarbon ring may include, for example, a C₅₋₁₆spirohydrocarbon ring such as spiro[4.4]nonane, spiro[4.5]decane, or spirobicyclohexane.

Examples of the ring-aggregated hydrocarbon ring may include a ring-aggregated hydrocarbon ring containing two or more C₅₋₁₂cycloalkane rings such as bicyclohexane.

The bridged cyclic hydrocarbon ring may include, for example, a bicyclic hydrocarbon ring such as pinane, bornane, norpinane, norbornane, norbornene, bicycloheptane, bicycloheptene, or bicyclooctane (such as bicyclo[2.2.2]octane or bicyclo[3.2.1]octane); a tricyclic hydrocarbon ring such as homobledane, adamantane, tricyclo[5.2.1.0^{2,6}]decane, or tricyclo[4.3.1.1^{2,5}]undecane; and a tetracyclic hydrocarbon ring such as tetracyclo[4.4.0.1^{2,5}.1^{7,10}]dodecane or perhydro-1,4-methano-5,8-methanonaphthalene.

Examples of the condensed cyclic hydrocarbon ring may include a condensed ring in which a plurality of 5- to 8-membered cycloalkane rings are condensed, such as perhydronaphthalene (decalin), perhydroanthracene, perhydrophenanthrene, perhydroacenaphthene, perhydrofluorene, perhydroindene, or perhydrophenalene.

The bridged condensed cyclic hydrocarbon ring may include, for example, a dimer of a diene compound (e.g., a dimer of a cycloalkadiene such as cyclopentadiene, cyclohexadiene, or cycloheptadiene) and a hydrogenated product thereof.

Examples of the divalent aromatic hydrocarbon group may include a C₆₋₁₈arylene group such as phenylene group, biphenylene group, or naphthylene group.

The divalent hydrocarbon group may have a variety of substituents [for example, a halogen atom, an oxo group, a substituted oxy group (such as an alkoxy group, an aryloxy group, an aralkyloxy group, or an acyloxy group), a carboxyl group, a substituted oxycarbonyl group (such as an alkoxycarbonyl group, an aryloxycarbonyl group, or an aralkyloxycarbonyl group), a substituted or unsubstituted carbamoyl group, a cyano group, a nitro group, a substituted or unsubstituted amino group, a sulfo group, and a heterocyclic group]. The carboxyl group may be protected with a protective group commonly used in the field of organic synthesis. Moreover, to a ring of the alicyclic hydrocarbon group or the aromatic hydrocarbon group, an aromatic or nonaromatic heterocyclic ring may be condensed.

The linkage group may include, for example, carbonyl group (—CO—), ether bond (—O—), thioether bond (—S—), ester bond (—COO—), amide bond (—CONH—), and carbonate bond (—OCOO—).

The heterocyclic ring of the divalent heterocyclic group may include, for example, a heterocyclic ring containing oxygen atom as a hetero atom (e.g., a 4-membered ring; a 5-membered ring such as furan ring, tetrahydrofuran ring, oxazole ring, isoxazole ring, or γ-butyrolactone ring; a 6-membered ring such as 4-oxo-4H-pyran ring, tetrahydropyran ring, or morpholine ring; a condensed ring such as benzofuran ring, isobenzofuran ring, 4-oxo-4H-chromene ring, chromane ring, or isochromane ring; and a bridged ring such as 3-oxatricyclo[4.3.1.1^{4,8}]undecan-2-one ring or 3-oxatricyclo[4.2.1.0^{4,8}]nonan-2-one ring), a heterocyclic ring containing sulfur atom as a hetero atom (e.g., a 5-membered ring such as thiophene ring, thiazole ring, isothiazole ring, or thiadiazole ring; a 6-membered ring such as 4-oxo-4H-thiopyran ring; and a condensed ring such as benzothiophene ring), and a heterocyclic ring containing nitrogen atom as a hetero atom (e.g., a 5-membered ring such as pyrrole ring, pyrrolidine ring, pyrazole ring, imidazole ring, or triazole ring; a 6-membered ring such as pyridine ring, pyridazine ring, pyrimidine ring, pyrazine ring, piperidine ring, or piperazine ring; and a condensed ring such as indole ring, indoline ring, quinoline ring, acridine ring, naphthyridine ring, quinazoline ring, or purine ring).

The divalent heterocyclic group may have the same substituent(s) as those of the divalent hydrocarbon group described above, an alkyl group (for example, a C₁₋₄alkyl group such as methyl group or ethyl group), a cycloalkyl group, an aryl group (for example, phenyl group, and naphthyl group), or other substituents. The divalent heterocyclic group may include a group in which two hydrogen atoms have been removed from the structural formula of the heterocyclic ring.

Preferred among the above-mentioned R^{a} is the divalent hydrocarbon group or the divalent group having two or more hydrocarbon groups coupled through linkage group(s). More preferred is a divalent aliphatic hydrocarbon group or a divalent group having two or more divalent aliphatic hydrocarbon groups coupled through linkage group(s). Most preferred is a straight-chain or branched-chain C₁₋₁₈alkylene group or a group having two or more straight-chain or branched-chain C₁₋₁₈alkylene groups coupled through linkage group(s), and especially preferred is a straight-chain or branched-chain C₁₋₆alkylene group or a group having two or more straight-chain or branched-chain C₁₋₆alkylene groups coupled through linkage group(s). Particularly preferred is a straight-chain or branched-chain C₁₋₆alkylene group. As the linkage group, an ether bond is preferred.

In terms of obtaining a cured product having a higher hardness, the compound (b) represented by the formula (5) preferably contains (b1) a compound having one vinyl ether group and one hydroxy group and/or (b3) a compound having one oxetane-ring-containing group and one hydroxy group, especially, preferably at least contains the compound (b3) having one oxetane-ring-containing group and one hydroxy group, and particularly, preferably at least contains both of the compound (b1) having one vinyl ether group and one hydroxy group and the compound (b3) having one oxetane-ring-containing group and one hydroxy group.

The hydroxy-group-containing polymerizable compound (B) preferably contains at least one compound selected from the group consisting of compounds represented by the following formulae (b1-1) to (b1-3) and (b3-1), and especially, preferably at least contains a compound represented by the following formula (b3-1). In particular, the hydroxy-group-containing polymerizable compound (B) preferably at least contains both of 4-hydroxybutyl vinyl ether represented by the following formula (b1-2) and 3-ethyl-3-hydroxymethyloxetane represented by the following formula (b3-1).

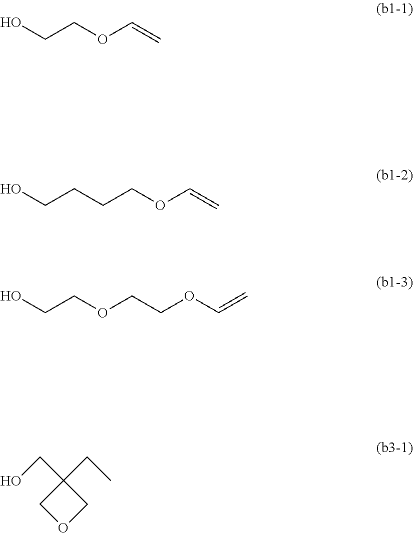

The proportion of the compound (b) having one hydroxy group and one cationic polymerizable group selected from the group consisting of a vinyl ether group, an epoxy group, and an oxetane-ring-containing group per molecule in the hydroxy-group-containing polymerizable compound (or second polymerizable compound) (B) may be selected from a range of, for example, not less than 10% by weight (e.g., about 30 to 100% by weight). The second polymerizable compound (B) may contain the compound (b) in a proportion of, for example, not less than 50% by weight (e.g., about 60 to 99.9% by weight), preferably not less than 70% by weight (e.g., about 80 to 99% by weight), more preferably not less than 90% by weight (e.g., about 95 to 98% by weight), and particularly 100% by weight (may substantially contain the compound (b) alone).

The proportion of the total amount of the compound (b1) having one vinyl ether group and one hydroxy group and the compound (b3) having one oxetane-ring-containing group and one hydroxy group in the hydroxy-group-containing polymerizable compound (second polymerizable compound) (B) [particularly, the compound (b)] may be selected from a range of, for example, not less than 10% by weight (e.g., about 30 to 100% by weight). The second polymerizable compound (B) may contain the compound (b1) and the compound (b3) in a total proportion of, for example, not less than 50% by weight (e.g., about 60 to 99.9% by weight), preferably not less than 70% by weight (e.g., about 80 to 99% by weight), more preferably not less than 90% by weight (e.g., about 95 to 98% by weight), and particularly 100% by weight (may substantially only contain the compound (b1) and/or the compound (b3)).

The proportion of the compound (b1) having one vinyl ether group and one hydroxy group in the hydroxy-group-containing polymerizable compound (second polymerizable compound) (B) [particularly the compound (b)] may be, for example, about 5 to 100% by weight (e.g., about 10 to 70% by weight), preferably about 12 to 50% by weight (e.g., about 15 to 40% by weight), and more preferably about 18 to 35% by weight (e.g., about 20 to 30% by weight).

The proportion of the compound (b3) having one oxetane-ring-containing group and one hydroxy group in the hydroxy-group-containing polymerizable compound (second polymerizable compound) (B) [particularly the compound (b)] may be, for example, about 20 to 100% by weight (e.g., about 40 to 95% by weight), preferably about 50 to 90% by weight (e.g., about 60 to 85% by weight), and more preferably about 65 to 82% by weight (e.g., about 70 to 80% by weight).

In a case where both of the compound (b1) having one vinyl ether group and one hydroxy group and the compound (b3) having one oxetane-ring-containing group and one hydroxy group are used, the ratio of the compound (b3) relative to the compound (b1) may be selected from a range of, for example, about 1/99 to 99/1 (e.g., about 10/90 to 95/5) in the compound (b3)/the compound (b1) (weight ratio) and may be, for example, about 30/70 to 92/8 (e.g., about 40/60 to 90/10), preferably about 50/50 to 88/12 (e.g., about 60/40 to 85/15), and more preferably about 65/35 to 82/18 (e.g., about 70/30 to 80/20). The ratio within such a range further facilitates the adhesion improvement and is thus preferred.

The ratio of the epoxy compound (first polymerizable compound) (A) [particularly the total amount of the first epoxy compound (A1) and the second epoxy compound (A2)] relative to the hydroxy-group-containing polymerizable compound (second polymerizable compound) (B) [preferably the compound (b), particularly the total amount of the compound (b1) and (b3)] may be selected from a range of about 1/99 to 99/1 (e.g., about 10/90 to 95/5) in the former/the latter (weight ratio) and may be, for example, about 20/80 to 90/10 (e.g., about 30/70 to 85/15), preferably about 40/60 to 80/20 (e.g., about 45/55 to 75/25), and more preferably about 50/50 to 70/30 (e.g., about 55/45 to 65/35). Too low a ratio of the epoxy compound (A) may result in decrease in hardness, heat resistance, sliding properties, abrasion resistance, or other properties.

[Another Polymerizable Compound (Third Polymerizable Compound)]

In an embodiment of the present invention, the curable composition may or may not optionally contain another polymerizable compound (third polymerizable compound) that neither belong to the epoxy compound (first polymerizable compound) (A) nor the hydroxy-group-containing polymerizable compound (second polymerizable compound) (B) within the range that does not damage the advantageous effects of the present invention. Such a third polymerizable compound may include, for example, a vinyl ether compound and an oxetane compound.

(Vinyl Ether Compound)

The vinyl ether compound may contain one or more kinds of compounds, each having at least one vinyl ether group and having no hydroxy group per molecule (excluding an epoxy-group-containing compound). The vinyl ether compound may have another cationic polymerizable group (for example, an oxetane-ring-containing group) in addition to a vinyl ether group.

The vinyl ether compound may include, for example, a compound represented by the following formula (6):

R⁴—(O—CH═CH₂)ₜ (6)

wherein t denotes an integer of not less than 1, R⁴ represents a t-valent hydrocarbon group, a t-valent heterocyclic group, or a t-valent group in which these t-valent groups are coupled through single bond(s) or linkage group(s).

The number t denotes an integer of not less than 1. For example, the number t is an integer of 1 to 10, preferably an integer of 1 to 5, and particularly preferably an integer of 2 to 5.

The t-valent hydrocarbon group and the t-valent heterocyclic group represented by the group R⁴ may include t-valent groups corresponding to the divalent hydrocarbon group and the divalent heterocyclic group as the group R^{a} described in the formula (5). The t-valent hydrocarbon group and the t-valent heterocyclic group may have a substituent. The substituent may include the same substituents as those of the divalent hydrocarbon group and the divalent heterocyclic group as the group R^{a} described in the formula (5), and a group containing an oxetane-ring-containing group. The linkage group may include the same linkage groups as those in the group R^{a} described in the formula (5). Preferred as the group R⁴ is a t-valent group having an alicyclic or heterocyclic skeleton.

The vinyl ether compound preferably includes compounds represented by the following formulae (6-1) and (6-2), cyclohexyl vinyl ether, cyclohexylmethyl vinyl ether, cyclohexylethyl vinyl ether, menthyl vinyl ether, tetrahydrofurfuryl vinyl ether, norbornenyl vinyl ether, 1-adamantyl vinyl ether, 2-adamantyl vinyl ether, 1,4-cyclohexanediol divinyl ether, 1,4-cyclohexanedimethanol divinyl ether, or other compounds.

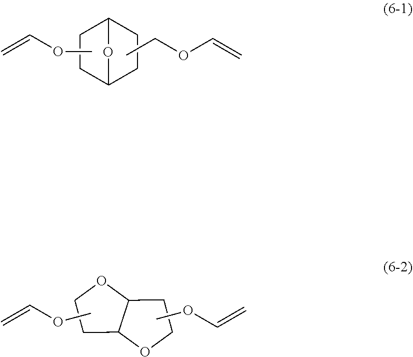

(Oxetane Compound)

The oxetane compound may contain one or more kinds of compounds, each having at least one oxetane-ring-containing group and having no hydroxy group per molecule (excluding a compound having vinyl ether group and/or epoxy group(s)). The oxetane compound is, for example, represented by the following formula (7):

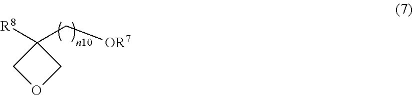

wherein R⁷ represents a monovalent organic group, R⁸ represents hydrogen atom or ethyl group, and n10 denotes an integer of not less than 0.

The monovalent organic group represented by R⁷ may include a monovalent hydrocarbon group, a monovalent heterocyclic group, a substituted oxycarbonyl group (such as an alkoxycarbonyl group, an aryloxycarbonyl group, an aralkyloxycarbonyl group, or a cycloalkyloxycarbonyl group), a substituted carbamoyl group (such as an N-alkylcarbamoyl group or an N-arylcarbamoyl group), an acyl group (e.g., an aliphatic acyl group such as acetyl group; and an aromatic acyl group such as benzoyl group), and a monovalent group in which two or more of these groups are coupled through single bond(s) or linkage group(s).

Each of the monovalent hydrocarbon group and the monovalent heterocyclic group may include a monovalent group in which one hydrogen atom has been coupled or bonded to the corresponding divalent hydrocarbon group or divalent heterocyclic group as the group R^{a} described in the formula (5). The linkage group may include the same linkage groups as those in the group R^{a} described in the formula (5). These groups may have a substituent. The substituent may include the same substituents as those of the hydrocarbon group in the group R^{a} described in the formula (5). The number n10 denotes an integer of not less than 0, and is, for example, 0 to 20 and preferably 0 or 1.

Among the oxetane compounds, use of a compound having two or more oxetane-ring-containing groups per molecule is preferred in terms of obtaining a curable composition having a fast curability and a cured product having a high hardness. For example, a compound represented by the following formula (7-1) and a compound represented by the following formula (7-2) are preferred. In an embodiment of the present invention, for example, there may be used a commercially available product including “ARON OXETANE OXT-221” or “ARON OXETANE OXT-121” manufactured by TOAGOSEI CO., LTD.

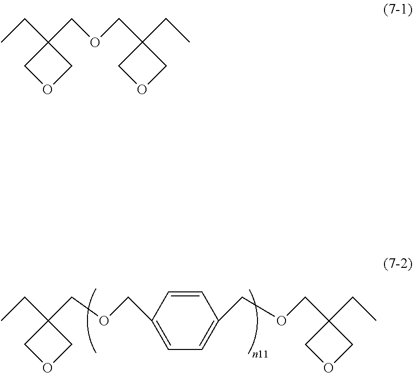

In the formula, n11 denotes 1 to 3.

These third polymerizable compounds may be used alone or in combination. The proportion of the total amount of the epoxy compound (A) and the hydroxy-group-containing polymerizable compound (B) (the total amount of the first and second polymerizable compounds) in the total amount of the polymerizable-group-containing compounds in the curable composition (the total amount of the first to third polymerizable compounds) may be selected from a range of, for example, not less than 10% by weight (for example, about 30 to 100% by weight). The whole polymerizable-group-containing compounds in the curable composition may contain the compounds (A) and (B) in a total proportion of, for example, not less than 50% by weight (e.g., about 60 to 99.9% by weight), preferably not less than 70% by weight (e.g., about 80 to 99% by weight), more preferably not less than 90% by weight (e.g., about 95 to 98% by weight), and particularly 100% by weight (may substantially only contain the epoxy compound (A) and the hydroxy-group-containing polymerizable compound (B)).

[(C) Leveling Agent]

The leveling agent (surface modifier or surfactant) has a leveling function (for example, a function reducing a surface tension) and can be a commonly used leveling agent (for example, an ethylene oxide adduct of acetylene glycol). In an embodiment of the present invention, combination of the specific epoxy compound (A) and the leveling agent (C) enables not only improvement in the surface smoothness and sliding properties but also the adhesion improvement, which is an unexpected function of a leveling agent.

The leveling agent is classified broadly into, for example, a silicone-series leveling agent, an acrylic leveling agent, a fluorine-containing leveling agent, and a vinyl-series leveling agent.

The silicone-series leveling agent includes a leveling agent having a polyorganosiloxane skeleton. The polyorganosiloxane skeleton includes a polyorganosiloxane having a monofunctional M unit (a unit typically represented by R³SiO_{1/2}), a difunctional D unit (a unit typically represented by R²SiO_{2/2}), a trifunctional T unit (a unit typically represented by RSiO_{3/2}), and/or a tetrafunctional Q unit (a unit typically represented by SiO_{4/2}). Typically, a polyorganosiloxane having the D unit is used.

The organic group (R) of the polyorganosiloxane may include, for example, a hydrocarbon group, an alkoxy group, an alkenyloxy group, an aryloxy group, an aralkyloxy group, an acyl group, an acyloxy group, an alkylthio group, an alkenylthio group, an arylthio group, an aralkylthio group, a carboxyl group, an alkoxycarbonyl group, an aryloxycarbonyl group, an aralkyloxycarbonyl group, an epoxy-group-containing group, an oxetane-ring-containing group, a cyano group, an isocyanate group, a carbamoyl group, an isothiocyanate group, and a substituted amino group.

The hydrocarbon group may include, for example, an aliphatic hydrocarbon group, an alicyclic hydrocarbon group, and an aromatic hydrocarbon group.

Examples of the aliphatic hydrocarbon group may include an alkyl group, an alkenyl group, and an alkynyl group. The alkyl group may include, for example, a straight-chain or branched-chain C₁₋₂₀alkyl group such as methyl group, ethyl group, propyl group, isopropyl group, butyl group, hexyl group, octyl group, isooctyl group, decyl group, or dodecyl group (preferably a C₁₋₁₀alkyl group, and more preferably a C₁₋₄alkyl group). Examples of the alkenyl group may include a straight-chain or branched-chain C₂₋₂₀alkenyl group such as vinyl group, allyl group, methallyl group, 1-propenyl group, isopropenyl group, butenyl group, pentenyl group, or hexenyl group (preferably a C₂₋₁₀alkenyl group, and more preferably a C₂₋₄alkenyl group). The alkynyl group may include, for example, a straight-chain or branched-chain C₂₋₂₀alkynyl group such as ethinyl group or propynyl group (preferably a C₂₋₁₀alkynyl group, and more preferably a C₂₋₄alkynyl group).

The alicyclic hydrocarbon group may include, for example, a C₃₋₁₂cycloalkyl group such as cyclopropyl group, cyclobutyl group, cyclopentyl group, cyclohexyl group, cyclooctyl group, or cyclododecyl group (particularly a C₅₋₈cycloalkyl group); a C₃₋₁₂cycloalkenyl group such as cyclohexenyl group; and a C₄₋₁₅ bridged cyclic hydrocarbon group such as bicycloheptanyl group or bicycloheptenyl group.

Examples of the aromatic hydrocarbon group may include a C₆₋₁₄aryl group such as phenyl group or naphthyl group (particularly a C₆₋₁₀aryl group).

The alkoxy group may include, for example, a straight-chain or branched-chain C₁₋₁₀alkoxy group such as methoxy group, ethoxy group, propoxy group, isopropyloxy group, butoxy group, or isobutyloxy group (preferably a C₁₋₆alkoxy group, and more preferably a C₁₋₄alkoxy group). Examples of the alkenyloxy group may include a straight-chain or branched-chain C₂₋₁₀alkenyloxy group such as allyloxy group (preferably a C₂₋₆alkenyloxy group, and more preferably C₂₋₄alkenyloxy group). The aryloxy group may include, for example, a C₆₋₂₀aryloxy group such as phenoxy group, tolyloxy group, or naphthyloxy group (particularly a C₆₋₁₄aryloxy group). Examples of the aralkyloxy group may include a C₇₋₂₀aralkyloxy group such as benzyloxy group or phenethyloxy group (particularly a C₇₋₁₈aralkyloxy group).

The acyl group may include, for example, a C₁₋₂₀acyl group such as acetyl group, propionyl group, (meth)acryloyl group, or benzoyl group (particularly a C₁₋₁₂acyl group). Examples of the acyloxy group may include a C₁₋₂₀acyloxy group such as acetyloxy group, propionyloxy group, (meth)acryloyloxy group, or benzoyloxy group (particularly a C₁₋₁₂acyloxy group).

The alkylthio group may include, for example, a straight-chain or branched-chain C₁₋₆alkylthio group such as methylthio group or ethylthio group (particularly a C₁₋₄alkylthio group). Examples of the alkenylthio group may include a straight-chain or branched-chain C₂₋₆alkenylthio group such as allylthio group (particularly a C₂₋₄alkenylthio group). The arylthio group may include, for example, a C₆₋₂₀arylthio group such as phenylthio group, tolylthio group, or naphthylthio group (particularly a C₆₋₁₄arylthio group). Examples of the aralkylthio group may include a C₇₋₂₀aralkylthio group such as benzylthio group or phenethylthio group (particularly a C₇₋₁₈aralkylthio group).

The alkoxycarbonyl group may include, for example, a straight-chain or branched-chain C₁₋₁₀alkoxy-carbonyl group such as methoxycarbonyl group, ethoxycarbonyl group, propoxycarbonyl group, or butoxycarbonyl group (particularly a C₁₋₆alkoxy-carbonyl group). Examples of the aryloxycarbonyl group may include a C₆₋₂₀aryloxy-carbonyl group such as phenoxycarbonyl group, tolyloxycarbonyl group, or naphthyloxycarbonyl group (particularly a C₆₋₁₄aryloxy-carbonyl group). The aralkyloxycarbonyl group may include, for example, a C₇₋₂₀aralkyloxy-carbonyl group such as benzyloxycarbonyl group (particularly a C₇₋₁₈aralkyloxy-carbonyl group).

The epoxy-group-containing group is any group having at least an oxirane ring skeleton and may include, for example, epoxy group (or oxiranyl group), 1-methyloxiranyl group (2-methyloxiran-2-yl group), a glycidyl-group-containing group (e.g., glycidyl group and methylglycidyl group (2-methyloxiran-2-yl-methyl group)), and an alicyclic epoxy group (e.g., an epoxycycloalkyl group such as 3,4-epoxycyclohexyl group, and an alkyl-epoxycycloalkyl group such as 3,4-epoxy-6-methylcyclohexyl group).

The oxetane-ring-containing group may include, for example, an oxetanyl group (e.g., oxetan-3-yl group) and an alkyloxetanyl group (e.g., a C₁₋₁₀alkyloxetanyl group such as 3-methyl-3-oxetanyl group or 3-ethyl-3-oxetanyl group).

Examples of the substituted amino group may include a mono- or di-alkylamino group such as methylamino group, ethylamino group, dimethylamino group, or diethylamino group (particularly a mono- or di-C₁₋₆alkylamino group) and a mono- or di-acylamino group such as acetylamino group, propionylamino group, or benzoylamino group (particularly a mono- or di-C₁₋₁₁acylamino group).

The organic group may be a group in which two or more kinds of organic groups are combined (or bonded). The combination of two or more kinds of organic groups may include, for example, a combination of an aliphatic hydrocarbon group and an alicyclic hydrocarbon group (such as cyclohexylmethyl group or methylcyclohexyl group), a combination of an aliphatic hydrocarbon group and an aromatic hydrocarbon group [e.g., a C₇₋₁₈aralkyl group such as benzyl group or phenethyl group (in particular, a C₇₋₁₀aralkyl group), a C₆₋₁₀aryl-C₂₋₆alkenyl group such as cinnamyl group, a C₁₋₄alkyl-substituted aryl group such as tolyl group, and a C₂₋₄alkenyl-substituted aryl group such as styryl group], a combination of an alkoxy group and an aliphatic hydrocarbon group (such as methoxyethyl group), and a combination of an aliphatic hydrocarbon group and an aryloxy group (such as methylphenoxy group).

The organic group may further have a substituent. The substituent may include, for example, a halogen atom, oxo group, hydroxy group, hydroperoxy group, amino group, and sulfo group.

In many embodiments, the organic groups (R) of the polyorganosiloxane includes a hydrocarbon group and/or a combination thereof, usually includes a C₁₋₁₂alkyl group (e.g., a C₁₋₄alkyl group), anaryl group, and/or an aralkyl group, and practically includes methyl group and/or phenyl group (particularly methyl group). The repeating number of siloxane units (the degree of polymerization) is, for example, about 2 to 3000, preferably about 3 to 2000, and preferably about 5 to 1000.

The acrylic leveling agent is any leveling agent having a poly(meth)acrylate [particularly a polyacrylate] skeleton. A carboxyl group in a side chain of the poly (meth) acrylate skeleton may be esterified (for example, alkyl-esterified) or may form a salt (for example, an organic salt such as an amine salt).

The fluorine-containing leveling agent is any leveling agent having a fluoroaliphatic hydrocarbon skeleton. The fluoroaliphatic hydrocarbon skeleton may include, for example, a fluoroC₁₋₁₀alkane skeleton such as fluoromethane, fluoroethane, fluoropropane, fluoroisopropane, fluorobutane, fluoroisobutane, fluoro-t-butane, fluoropentane, or fluorohexane skeleton.

Each one of these fluoroaliphatic hydrocarbon skeletons has at least one fluorine atom substituted in place of at least one hydrogen atom on the parent skeleton. In order to improve the sliding properties and the rigidity, a perfluoroaliphatic hydrocarbon skeleton in which all hydrogen atoms on the parent skeleton have been replaced with fluorine atoms is preferred.

The fluoroaliphatic hydrocarbon skeleton may have a polyfluoroalkylene ether skeleton, which is a repeating unit through an ether bond. The fluoroaliphatic hydrocarbon group as the repeating unit may be at least one member selected from the group consisting of fluoroC₁₋₄alkylene groups, for example, fluoromethylene group, fluoroethylene group, fluoropropylene group, and fluoroisopropylene group. These fluoroaliphatic hydrocarbon groups may be the same or different from each other. The repeating number of fluoroalkylene ether units (the degree of polymerization) may be, for example, about 10 to 3000, preferably about 30 to 1000, and more preferably about 50 to 500.

The vinyl-series leveling agent has a polymer skeleton of a vinyl compound.

These leveling agents may have one or more of the skeletons as exemplified above. For example, the silicone-series leveling agent may have a poly(meth)acrylate skeleton or a fluoroaliphatic hydrocarbon group, the acrylic leveling agent may have a polyorganosiloxane skeleton, or the fluorine-containing leveling agent may have a polyorganosiloxane skeleton.

In order to impart various functions to the curable composition, these leveling agents may have, for example, a functional group such as a hydrolytic group (a hydrolytically condensable group), a reactive group to an epoxy group, a radical-polymerizable group, a polyether group, a polyester group, or a polyurethane group.

The hydrolysable group may include, for example, hydroxysilyl group; a trihalosilyl group (such as trichlorosilyl group); a dihaloC₁₋₄alkylsilylgroup (such as dichloromethylsilyl group); a dihaloarylsilyl group (such as dichlorophenylsilyl group); a halodiC₁₋₄alkylsilyl group (such as chlorodimethylsilyl group); a triC₁₋₄alkoxysilyl group (such as trimethoxysilyl group or triethoxysilyl group); a diC₁₋₄alkoxyC₁₋₄alkylsilyl group (such as dimethoxymethylsilyl group or diethoxymethylsilyl group); a diC₁₋₄alkoxyarylsilyl group (such as dimethoxyphenylsilyl group or diethoxyphenylsilyl group); a C₁₋₄alkoxydiC₁₋₄alkylsilyl group (such as methoxydimethylsilyl group or ethoxydimethylsilyl group); a C₁₋₄alkoxydiarylsilyl group (such as methoxydiphenylsilyl group or ethoxydiphenylsilyl group); and a C₁₋₄alkoxyC₁₋₄alkylarylsilyl group (such as methoxymethylphenylsilyl group or ethoxymethylphenylsilyl group). Preferred among these groups is the triC₁₋₄alkoxysilyl group, such as trimethoxysilyl group, in light of the reactivity or others.

The reactive group to an epoxy group may include, for example, a hydroxy group (hydroxyl group), an amino group, a carboxyl group, an acid anhydride group (such as maleic anhydride group), and an isocyanate group. Widely used among these groups are the hydroxy group, the amino group, the acid anhydride group, the isocyanate group, or other groups in light of the reactivity or others. In light of more easiness of the adhesion improvement and easiness of handling or obtaining, the hydroxy group is preferred.

The radical-polymerizable group may include, for example, a (meth)acryloyloxy group and a vinyl group. Widely used among these groups is the (meth)acryloyloxy group.

The polyether group may include, for example, a polyoxyC₂₋₄alkylene group such as a polyoxyethylene group, a polyoxypropylene group, a polyoxybutylene group, or a polyoxyethylene-polyoxypropylene group. In the polyether group, the repeating number of oxyalkylene groups (the mole number of oxyalkylene groups) is, for example, about 2 to 1000, preferably about 3 to 100, and preferably about 5 to 50. Preferred among these groups is a polyoxyC₂₋₃alkylene group such as a polyoxyethylene group or a polyoxypropylene group (particularly a polyoxyethylene group).

The polyester group may include, for example, a polyester group obtainable by a reaction of a dicarboxylic acid [e.g., an aromatic carboxylic acid (such as terephthalic acid) or an aliphatic carboxylic acid (such as adipic acid)] and a diol (e.g., an aliphatic diol such as ethylene glycol) and a polyester group obtainable by a ring opening polymerization of a circular ester (e.g., a lactone such as caprolactone).

The polyurethane group may include, for example, a conventional polyester-based polyurethane group and a polyether-based polyurethane group.

Each one of these functional groups may be introduced into the polyorganosiloxane skeleton, the poly(meth)acrylate skeleton, or the fluoroaliphatic hydrocarbon skeleton by direct bonding or through a linkage group (for example, an alkylene group, a cycloalkylene group, an ether bond, an ester bond, an amide bond, a urethane bond, or a linkage group having a plurality of the above-mentioned groups and/or bonds).

Preferred among these functional groups are the hydrolytically condensable group and the reactive group to an epoxy group (preferably the reactive group to an epoxy group, particularly the hydroxy group) in the respect that the functional group can be allowed to react with the epoxy compound (A) to improve the hardness of the cured product. Further, in terms of further adhesion improvement, the hydroxy group is particularly preferred.

The hydroxy group may be a terminal hydroxy group of a (poly)oxyalkylene group [such as a (poly)oxyethylene group]. Such a leveling agent may include, for example, a silicone-series leveling agent (e.g., a polydimethylsiloxanepolyoxyethylene) having a (poly)oxyC₂₋₃alkylene group (such as a (poly)oxyethylene group) on a side chain of a polyorganosiloxane skeleton (such as a polydimethylsiloxane); and a fluorine-containing leveling agent (e.g., a fluoroalkylpolyoxyethylene) having a fluoroaliphatic hydrocarbon group on a side chain of a (poly)oxyC₂₋₃alkylene skeleton (such as a (poly)oxyethylene).

As the silicone-series leveling agent, a commercially available silicone-series leveling agent may be used. The commercially available silicone-series leveling agent may include, for example, a BYK series leveling agent manufactured by BYK Japan KK (e.g., “BYK-300”, “BYK-301/302”, “BYK-306”, “BYK-307”, “BYK-310”, “BYK-313”, “BYK-315”, “BYK-315N”, “BYK-320”, “BYK-322”, “BYK-323”, “BYK-325”, “BYK-326”, “BYK-330”, “BYK-331”, “BYK-333”, “BYK-337”, “BYK-341”, “BYK-342”, “BYK-344”, “BYK-345/346”, “BYK-347”, “BYK-348”, “BYK-349”, “BYK-370”, “BYK-375”, “BYK-377”, “BYK-378”, “BYK-UV3500”, “BYK-3505”, “BYK-UV3510”, “BYK-UV3530”, “BYK-UV3570”, “BYK-UV3575”, “BYK-UV3576”, “BYK-3550”, “BYK-3565”, “BYK-SILCLEAN3700”, “BYK-SILCLEAN3701”, and “BYK-SILCLEAN3720”); an AC series leveling agent manufactured by Algin Chemie (e.g., “AC FS180”, “AC FS360”, and “AC S20”); a POLYFLOW series leveling agent manufactured by Kyoeisha Chemical Co., Ltd. (e.g., “POLYFLOW KL-400X”, “POLYFLOW KL-400HF”, “POLYFLOW KL-401”, “POLYFLOW KL-402”, “POLYFLOW KL-403”, and “POLYFLOW KL-404”); a KP series leveling agent manufactured by Shin-Etsu Chemical Co., Ltd. (e.g., “KP-323”, “KP-326”, “KP-341”, “KP-104”, “KP-110”, and “KP-112”); a leveling agent manufactured by Dow Corning Toray Co., Ltd. (e.g., “LP-7001”, “LP-7002”, “8032ADDITIVE”, “57ADDITIVE”, “L-7604”, “FZ-2110”, “FZ-2105”, “67ADDITIVE”, “8616ADDITIVE”, “3ADDITIVE”, and “56ADDITIVE”); and a DISPARLON series leveling agent manufactured by Kusumoto Chemicals, Ltd. (e.g., “UVX-272”, “LHP-810”, “NSH-8430HF”, “1711EF”, “1761”, “LS-001”, “LS-050”, “LS-460”, “LS-480”, “LHP-91”, and “LHP-96”).

As the acrylic leveling agent, a commercially available acrylic leveling agent may be used. The commercially available acrylic leveling agent may include, for example, a BYK series leveling agent manufactured by BYK Japan KK (e.g., “BYK-350”, “BYK-352”, “BYK-354”, “BYK-355/356”, “BYK-358N/361N”, “BYK-381”, “BYK-392”, “BYK-394”, “BYK-3440”, and “BYK-3441”); a POLYFLOW series leveling agent manufactured by Kyoeisha Chemical Co., Ltd. (e.g., “POLYFLOW No. 7”, “POLYFLOW No. 50E”, “POLYFLOW No. 50EHF”, “POLYFLOW No. 54N”, “POLYFLOW No. 55”, “POLYFLOW No. 75”, “POLYFLOW No. 77”, “POLYFLOW No. 85”, “POLYFLOW No. 85HF”, “POLYFLOW No. 90”, “POLYFLOW No. 90D-50”, “POLYFLOW No. 95”, and “POLYFLOW No. 99C”); and a DISPARLON series leveling agent manufactured by Kusumoto Chemicals, Ltd. (e.g., “1970”, “230”, “230HF”, “LF-1980”, “LF-1982”, “LF-1983”, “LF-1984”, “LF-1985”, “UVX-35”, and “UVX-36”).

As the fluorine-containing leveling agent, a commercially available fluorine-containing leveling agent may be used. The commercially available fluorine-containing leveling agent may include, for example, an OPTOOL series leveling agent manufactured by Daikin Industries, Ltd. (e.g., “DSX” and “DAC-HP”); a SURFLON series leveling agent manufactured by AGC Seimi Chemical Co., Ltd. (e.g., “S-211”, “S-221”, “S-231”, “S-241”, “S-242”, “S-243”, “S-420”, “S-611”, “S-651”, and “S-386”); a BYK series leveling agent manufactured by BYK Japan KK (e.g., “BYK-340”); an AC series leveling agent manufactured by Algin Chemie (e.g., “AC 110a” and “AC 100a”); a MEGAFACE series leveling agent manufactured by DIC Corporation (e.g., “MEGAFACE F-114”, “MEGAFACE F-410”, “MEGAFACE F-430”, “MEGAFACE F-444”, “MEGAFACE F-472SF”, “MEGAFACE F-477”, “MEGAFACE F-552”, “MEGAFACE F-553”, “MEGAFACE F-554”, “MEGAFACE F-555”, “MEGAFACE F-556”, “MEGAFACE F-558”, “MEGAFACE EXP TP-2066”, “MEGAFACE EXP TF-1367”, “MEGAFACE EXP TF-1437”, “MEGAFACE EXP TF-1537”, “MEGAFACE R-94”, “MEGAFACE RS-72-K”, and “MEGAFACE RS-75”); a FC series leveling agent manufactured by Sumitomo 3M Limited (e.g., “FC-4430” and “FC-4432”); a FTERGENT series leveling agent manufactured by Neos Company Limited (e.g., “FTERGENT 100”, “FTERGENT 100C”, “FTERGENT 110”, “FTERGENT 150”, “FTERGENT 150CH”, “FTERGENT A-K”, “FTERGENT 501”, “FTERGENT 250”, “FTERGENT 251”, “FTERGENT 222F”, “FTERGENT 208G”, “FTERGENT 300”, “FTERGENT 310”, “FTERGENT 320”, and “FTERGENT 400SW”); and a PF series leveling agent manufactured by Kitamura Chemicals Co., Ltd. (e.g., “PF-136A”, “PF-156A”, “PF-151N”, “PF-636”, “PF-6320”, “PF-656”, “PF-6520”, “PF-651”, “PF-652”, “PF-652-NF”, and “PF-3320”).

As the vinyl-series leveling agent, a commercially available vinyl-series leveling agent may be used. The commercially available vinyl-series leveling agent may include, for example, a DISPARLON series leveling agent manufactured by Kusumoto Chemicals, Ltd. (e.g., “LHP-90” and “LHP-95”).

These leveling agents may be used alone or in combination. For example, a plurality of leveling agents of the same kind (e.g., two or more silicone-series leveling agents, two or more acrylic leveling agents) may be used in combination, or a plurality of leveling agents of different kinds (e.g., a silicone-series leveling agent and an acrylic leveling agent) may be used in combination. In terms of easiness of the adhesion improvement, preferred among these leveling agents are the silicone-series leveling agent, the acrylic leveling agent, or other agents. Among them, a leveling agent at least having the polyorganosiloxane skeleton (particularly the silicone-series leveling agent) is preferred.

The proportion of the silicone-series leveling agent in the leveling agent (C) may be selected from a range of, for example, not less than 10% by weight (e.g., 30 to 100% by weight). The leveling agent (C) may contain the silicone-series leveling agent in a proportion of, for example, not less than 50% by weight (e.g., about 60 to 99.9% by weight), preferably not less than 70% by weight (e.g., about 80 to 99% by weight), more preferably not less than 90% by weight (e.g., about 95 to 98% by weight), and particularly 100% by weight (may substantially contain the silicone-series leveling agent alone).

In terms of further adhesion improvement and, in addition, hardness improvement due to reactivity to an epoxy group, the leveling agent (C) preferably contains the hydroxy-group-containing leveling agent, but which is not necessarily needed.

The hydroxy-group-containing leveling agent may have a hydroxyl value in terms of solid content (or effective component) of, for example, not less than 10 mgKOH/g (e.g., about 15 to 100 mgKOH/g), preferably not less than 20 mgKOH/g (e.g., about 25 to 80 mgKOH/g), more preferably not less than 30 mgKOH/g (e.g., about 35 to 60 mgKOH/g), and particularly not less than 38 mgKOH/g (e.g., about 40 to 50 mgKOH/g). In a case where the hydroxyl value is too low, an adhesion-improving effect may be shown insufficiently.

Such a hydroxy-group-containing leveling agent may include, for example, “BYK-370”, “BYK-375”, “BYK-377”, “BYK-SILCLEAN3700”, “BYK-SILCLEAN3720”, and “BYK-394”, each manufactured by BYK Japan KK.

These hydroxy-group-containing leveling agents may be used alone or in combination. Preferred among these hydroxy-group-containing leveling agents is the silicone-series hydroxy-group-containing leveling agent. The silicone-series hydroxy-group-containing leveling agent may include, for example, a polyether-modified polyorganosiloxane in which a main chain or side chain of a polyorganosiloxane skeleton (such as a polydimethylsiloxane) has a polyether group, a polyester-modified polyorganosiloxane in which a main chain or side chain of a polyorganosiloxane skeleton has a polyester group, and a silicone-modified (meth) acrylic resin in which a (meth)acrylic resin (or a poly(meth)acrylate skeleton) has a polyorganosiloxane skeleton. For each one of these leveling agents, the polyorganosiloxane skeleton may have a hydroxy group, or the polyether group, the polyester group, or the (meth)acrylic resin may have a hydroxy group. More specifically, for example, such a leveling agent may include “BYK-370”, “BYK-375”, “BYK-377”, “BYK-SILCLEAN3700”, and “BYK-SILCLEAN3720”, each manufactured by BYK Japan KK. Preferred among these leveling agents are “BYK-370”, “BYK-375”, and “BYK-377” (particularly “BYK-377”).

The proportion of the hydroxy-group-containing leveling agent (particularly the silicone-series hydroxy-group-containing leveling agent) in the leveling agent (C) may be selected from a range of, for example, not less than 10% by weight (e.g., about 30 to 100% by weight). The leveling agent (C) may contain the hydroxy-group-containing leveling agent (particularly the silicone-series hydroxy-group-containing leveling agent) in a proportion of, for example, not less than 50% by weight (e.g., about 60 to 99.9% by weight), preferably not less than 70% by weight (e.g., about 80 to 99% by weight), more preferably not less than 90% by weight (e.g., about 95 to 98% by weight), and particularly 100% by weight [may substantially contain the hydroxy-group-containing leveling agent (particularly the silicone-series hydroxy-group-containing leveling agent) alone].

The ratio of the leveling agent (C) relative to 100 parts by weight of the total amount of the polymerizable compounds (the total amount of the first to third polymerizable compounds) may be selected from a range of, for example, about 0.001 to 10 parts by weight (e.g., about 0.01 to 1 part by weight) and may be, for example, about 0.05 to 0.8 parts by weight (e.g., about 0.1 to 0.5 parts by weight), preferably about 0.12 to 0.45 parts by weight (e.g., about 0.15 to 0.4 parts by weight), and more preferably about 0.18 to 0.35 parts by weight (e.g., about 0.2 to 0.3 parts by weight) or may usually be about 0.1 to 0.9 parts by weight (e.g., about 0.25 to 0.75 parts by weight), preferably about 0.3 to 0.7 parts by weight (e.g., about 0.35 to 0.65 parts by weight), and particularly about 0.4 to 0.6 parts by weight (e.g., about 0.45 to 0.55 parts by weight).

The ratio of the leveling agent (C) relative to 100 parts by weight of the epoxy compound (A) may be selected from a range of, for example, about 0.001 to 10 parts by weight (e.g., about 0.01 to 2 parts by weight) and may be, for example, about 0.1 to 1.5 parts by weight (e.g., about 0.2 to 1.2 parts by weight), preferably about 0.3 to 1 part by weight (e.g., about 0.35 to 0.95 parts by weight), and more preferably about 0.4 to 0.9 parts by weight (e.g., about 0.6 to 0.93 parts by weight, preferably about 0.7 to 0.9 parts by weight).

The leveling agent (C) in an excessively small ratio may decrease not only the adhesion but also the smoothness or sliding properties of the cured product. The leveling agent (C) in an excessively large ratio may decrease the hardness of the cured product.

[(D) Solvent]

The curable composition may contain, but not necessarily need, a solvent (D) if necessary. As the solvent (D), a conventional solvent may be used. It is preferred that the solvent at least contain (D1) a high-boiling solvent.

((D1) High-boiling solvent (first solvent))

The high-boiling solvent (D1) has a high boiling point. Representatively, the boiling point of the high-boiling solvent (D1) may be selected from a range of, for example, not lower than 100° C. (e.g., about 130 to 300° C., preferably about 135 to 270° C.) and may be, for example, not lower than 150° C. (e.g., about 170 to 250° C.), preferably not lower than 180° C. (e.g., about 185 to 230° C.), more preferably not lower than 190° C. (e.g., about 195 to 220° C.), and particularly about 200 to 210° C. Such a high-boiling solvent (D1) may specifically include, for example, an alkyl-group-containing aromatic hydrocarbon compound and a cyclic ester compound.

The alkyl-group-containing aromatic hydrocarbon compound may include, for example, a straight-chain or branched-chain alkylbenzene compound such as toluene, xylene (o-xylene, m-xylene, p-xylene), ethylbenzene, trimethylbenzene (1,2,3-trimethylbenzene, 1,2,4-trimethylbenzene, 1,3,5-trimethylbenzene), ethyltoluene (o-ethyltoluene, m-ethyltoluene, p-ethyltoluene), cumene, propylbenzene, tetramethylbenzene (1,2,3,4-tetramethylbenzene, 1,2,3,5-tetramethylbenzene, 1,2,4,5-tetramethylbenzene), diethylbenzene (o-diethylbenzene, m-diethylbenzene, p-diethylbenzene), cymene (such as p-cymene), propyltoluene (such as p-propyltoluene), butylbenzene (n-butylbenzene, isobutylbenzene, s-butylbenzene, t-butylbenzene), or pentylbenzene (such as n-pentylbenzene), preferably a mono- to tetra-C₁₋₆alkyl-benzene (e.g., a mono- to tetra-C₁₋₄alkyl-benzene).

The alkyl-group-containing aromatic hydrocarbon compound may also include a hydrocarbon-series mixed solvent containing at least one member selected from the solvents specifically exemplified above (straight-chain or branched-chain alkylbenzene compounds), for example, a hydrocarbon-series mixed solvent derived from petroleum or coal (such as solvent naphtha, mineral spirit, or white spirit).

These alkyl-group-containing aromatic hydrocarbon compounds may be used alone or in combination. Preferred among these alkyl-group-containing aromatic hydrocarbon compounds are a mono- to tri-C₁₋₃alkyl-benzene such as xylene or 1,2,4-trimethylbenzene, solvent naphtha, white spirit, or other compounds. Particularly preferred are xylene, 1,2,4-trimethylbenzene, solvent naphtha, or other compounds.

Examples of the cyclic ester compound may include a 4- to 7-membered lactones which may have a straight-chain or branched-chain alkyl group (e.g., a C₁₋₆alkyl group) such as β-propiolactone, γ-butyrolactone, γ-valerolactone, γ-caprolactone (γ-hexanolactone), δ-valerolactone, δ-caprolactone, or ε-caprolactone, for example, a 5- to 6-membered lactone which may have a C₁₋₄alkyl group. These cyclic ester compounds may be used alone or in combination. Preferred among these cyclic ester compounds is, for example, a 5-membered lactone which may have a C₁₋₃alkyl group, such as γ-butyrolactone.

Such a first solvent (D1) may be a single solvent or a mixed solvent. From the point of view of the adhesion improvement, it is preferred that the solvent (D) contain at least one solvent selected from the group consisting of these first solvents (D1). It is more preferred that the solvent (D) contain at least one solvent selected from the group consisting of the alkyl-group-containing aromatic hydrocarbon compound and the cyclic ester compound (particularly at least the cyclic ester compound). In particular, a mixed solvent containing both alkyl-group-containing aromatic hydrocarbon compound and cyclic ester compound is preferred.

For such a mixed solvent, the ratio of the alkyl-group-containing aromatic hydrocarbon compound relative to the cyclic ester compound may be selected from a range of, for example, about 1/99 to 99/1 (e.g., about 10/90 to 90/10) in the former/the latter (weight ratio) and may be, for example, about 20/80 to 80/20 (e.g., about 30/70 to 70/30) and preferably about 40/60 to 60/40 (e.g., about 45/55 to 55/45).

The solvent (D) which contains the high-boiling solvent (D1) unexpectedly appears to allow an improved adhesion of the cured product. Although the reason for this is not clear, it is presumed that a cured product obtainable by subjecting the composition to a heat treatment such as a curing step contains a slight amount of the remaining high-boiling solvent (D1) which may have some interaction with the cured product or substrate.

((D2) Another Solvent (Second Solvent))

The solvent (D) may optionally contain (D2) another solvent (second solvent) that does not belong to the high-boiling solvent (D1). The second solvent (D2) may include, but should not be limited to, a conventional solvent, for example, a ketone compound (such as acetone, methyl ethyl ketone, methyl isobutyl ketone, or cyclohexanone), an ether compound (such as diethyl ether, diisopropyl ether, dioxane, or tetrahydrofuran), an aliphatic hydrocarbon compound (such as hexane), an alicyclic hydrocarbon compound (such as cyclohexane), benzene, a halocarbon compound (such as dichloromethane or dichloroethane), an ester compound (such as methyl acetate or ethyl acetate), water, an alcohol compound (such as ethanol, isopropanol, butanol, or cyclohexanol), a cellosolve compound (such as methyl cellosolve or ethyl cellosolve), a cellosolve acetate compound (such as methoxypropyl acetate), and an amide compound (such as dimethylformamide or dimethylacetamide). These solvents may be used alone or in combination.

Each of the high-boiling solvent (D1) and the second solvent (D2) may be used alone or in combination. In a case where the solvent (D) at least contains the high-boiling solvent (D1), the proportion of the high-boiling solvent (D1) may be selected from, but should not be limited to, for example, a range of not less than 1% by weight (e.g., about 10 to 100% by weight) in the solvent (D). The solvent (D) may contain the first solvent (D1) in a proportion of, for example, not less than 30% by weight (e.g., about 50 to 99.9% by weight), preferably not less than 70% by weight (e.g., about 80 to 99% by weight), more preferably not less than 90% by weight (e.g., about 95 to 98% by weight), and particularly 100% by weight [may substantially contain the high-boiling solvent (D1) alone].

The curable composition containing the solvent (D) has a nonlimiting solid content weight so that the curable liquid composition may have a viscosity suitable for a process for forming the composition into a desired product. In an embodiment of the present invention, the curable composition is often relatively easy to handle, and thus the composition may not necessarily contain the solvent (D) or may contain a small or slight amount of the solvent (D). Accordingly, the representative ratio of the solvent (D) (particularly the high-boiling solvent (D1)) relative to 100 parts by weight of the total amount of the polymerizable compounds (the total amount of the first to third polymerizable compounds) may be selected from a range of, for example, about 0 to 5 parts by weight (e.g., about 0.001 to 3 parts by weight) and may be, for example, about 0.01 to 1 part by weight (e.g., about 0.05 to 0.8 parts by weight), preferably about 0.08 to 0.5 parts by weight (e.g., about 0.1 to 0.4 parts by weight), and more preferably about 0.15 to 0.35 parts by weight (e.g., about 0.2 to 0.3 parts by weight). In a case where the solvent (D) (particularly the high-boiling solvent (D1)) is too much, a large amount of the solvent (D) may remain in the cured product, reducing the hardness or abrasion resistance of the cured product (particularly the abrasion resistance under a high load environment). Moreover, such a large amount of the solvent (D) may take time to dry in the forming process, may make it difficult to apply the composition to a substance having a low solvent resistance, or may fail to reduce an odor generated by volatilization of the solvent.

The solvent (D) may also be added together with the polymerizable compounds, the leveling agent (C), a conventional additive, or others. For example, some commercially available leveling agents specifically exemplified in the section of the leveling agent (C) are products on sale in the form of a solution containing the leveling agent (C) and a solvent. The solvent contained in such a product may be used as the solvent (D) in part or in whole. Representative examples of the leveling agent on sale in the form of a solution containing the high-boiling solvent (D1) includes “BYK-320”, “BYK-325”, and “BYK-370”, each manufactured by BYK Japan KK. Among them, “BYK-325” is preferred.

Thus, the ratio of the solvent (D) (particularly the high-boiling solvent (D1)) relative to 100 parts by weight of the leveling agent (C) may be selected from a range of, for example, about 0 to 1000 parts by weight (e.g., about 10 to 800 parts by weight) and may be, for example, about 30 to 500 parts by weight (e.g., about 50 to 400 parts by weight), preferably about 60 to 300 parts by weight (e.g., about 70 to 200 parts by weight), and more preferably about 80 to 150 parts by weight (e.g., about 85 to 100 parts by weight). In a case where the solvent (D) (particularly the high-boiling solvent (D1)) is too much, a large amount of the solvent (D) may remain in the cured product, reducing the hardness or abrasion resistance of the cured product (particularly the abrasion resistance under a high load environment).

[Curing Agent]

In many embodiments of the present invention, the curable composition contains a curing agent. The curing agent may be a commonly used curing agent [for example, an acid and an acid anhydride curing agent, an amine curing agent, polyaminoamide curing agent, an imidazole curing agent, an organic acid hydrazide curing agent, a latent curing agent (e.g., a dicyandiamide), a polymercaptan curing agent, and a phenolic curing agent] or may be a polymerization initiator, e.g., a cationic polymerization initiator (acid generator) that can initiate cationic polymerization.

Widely used among these curing agents is the cationic polymerization initiator (acid generator) or the amine curing agent. The cationic polymerization initiator includes a photoacid generator and a thermal acid generator, according to the type of the polymerization.

The photoacid generator may include, for example, a sulfonium salt (a salt of a sulfonium ion and an anion), a diazonium salt (a salt of a diazonium ion and an anion), an iodonium salt (a salt of an iodonium ion and an anion), a selenium salt (a salt of a selenium ion and an anion), an ammonium salt (a salt of an ammonium ion and an anion), a phosphonium salt (a salt of a phosphonium ion and an anion), an oxonium salt (a salt of an oxonium ion and an anion), a salt of a transition metal complex ion and an anion, and a bromine compound. These photoacid generators may be used alone or in combination. Preferred among these photoacid generators is an acid generator having a high acidity, e.g., the sulfonium salt, from the point that the reactivity and the hardness of the cured product can be improved.

The sulfonium salt may include, for example, a triarylsulfonium salt [such as a triphenylsulfonium salt, a tri-p-tolylsulfonium salt, a tri-o-tolylsulfonium salt, a tris(4-methoxyphenyl)sulfonium salt, a 1-naphthyldiphenylsulfonium salt, a 2-naphthyldiphenylsulfonium salt, a tris(4-fluorophenyl)sulfonium salt, a tri-1-naphthylsulfonium salt, a tri-2-naphthylsulfonium salt, a tris(4-hydroxyphenyl)sulfonium salt, a diphenyl[4-(phenylthio)phenyl]sulfonium salt, a [4-(4-biphenylthio)phenyl]-4-biphenylphenylsulfonium salt, or a 4-(p-tolylthio)phenyldi-(p-phenyl)sulfonium salt]; a diarylsulfonium salt (such as a diphenylphenacylsulfonium salt, a diphenyl-4-nitrophenacylsulfonium salt, a diphenylbenzylsulfonium salt, or a diphenylmethylsulfonium salt); a monoarylsulfonium salt (such as a phenylmethylbenzylsulfonium salt, a 4-hydroxyphenylmethylbenzylsulfonium salt, or a 4-methoxyphenylmethylbenzylsulfonium salt); and a trialkylsulfonium salt (such as a dimethylphenacylsulfonium salt, a phenacyltetrahydrothiophenium salt, or a dimethylbenzylsulfonium salt). These sulfonium salts may be used alone or in combination. Among these sulfonium salts, the triarylsulfonium salt is preferred.

The anion (counter ion) for forming a salt with a cation may include, for example, SbF⁻⁶, PF⁻⁶, BF⁻⁴, a fluoroalkylfluorophosphate ion [such as (CF₃CF₂)₃PF³⁻ or (CF₃CF₂CF₂)₃PF³⁻], (C₆F₅)₄B⁻, (C₆F₅)₄Ga⁻, a sulfonate anion (such as trifluoromethanesulfonate anion, pentafluoroethanesulfonate anion, nonafluorobutanesulfonate anion, methanesulfonate anion, benzenesulfonate anion, or p-toluenesulfonate anion), (CF₃SO₂)₃C⁻, (CF₃SO₂)₂N⁻, a perhalogenate ion, a halosulfonate ion, a sulfate ion, a carbonate ion, an aluminate ion, a hexafluorobismuthate ion, a carboxylate ion, an arylborate ion, a thiocyanate ion, and a nitrate ion. These anions may be used alone or in combination. Widely used among these anions are, for example, SbF₆⁻, PF₆⁻, and the fluoroalkylfluorophosphate ion. The fluoroalkylfluorophosphate ion is preferred in light of solubility and others. In many embodiments, the anion is usually PF₆⁻.

As the photoacid generator, a commercially available photoacid generator may be used. The commercially available photoacid generator to be utilized may include, for example, “CPI-101A”, “CPI-110A”, “CPI-100P”, “CPI-110P”, “CPI-210S”, and “CPI-200K”, each manufactured by San-Apro Ltd.; “CYRACURE UVI-6990” and “CYRACURE UVI-6992”, each manufactured by The Dow Chemical Company; “UVACURE1590” manufactured by DAICEL-ALLNEX LTD.; “CD-1010”, “CD-1011”, and “CD-1012”, each manufactured by SARTOMER (US); “IRGACURE 264” manufactured by BASF SE; “CIT-1682” manufactured by Nippon Soda Co., Ltd.; and “PHOTOINITIATOR 2074” manufactured by Rhodia Japan, Ltd.

The thermal acid generator may include, for example, an arylsulfonium salt, an aryliodonium salt, an allene-ion complex, a quaternary ammonium salt, an aluminum chelate, and a boron trifluoride amine complex. These thermal acid generators may be used alone or in combination. Among these thermal acid generators, an acid generator having a high acidity, e.g., the arylsulfonium salt, is preferred from the point that the reactivity and the hardness of the cured product can be improved. As the anion, there may be mentioned anions as described in the photoacid generator. The anion may be an antimony fluoride ion, such as SbF⁶⁻.

As the thermal acid generator, a commercially available thermal acid generator may be used. The commercially available thermal acid generator may include, for example, a thermal acid generator manufactured by Sanshin Chemical Industry Co., Ltd. (such as “SAN-AID SI-60L”, “SAN-AID SI-60S”, “SAN-AID SI-80L”, or “SAN-AID SI-100L”) and a thermal acid generator manufactured by ADEKA Corporation (such as “SP-66” or “SP-77”). Widely used among these thermal acid generators is, for example, an aromatic sulfonium salt such as “SAN-AID SI-100L”.

Some of these photoacid or thermal acid generators can generate an acid by any of actions of light and heat.

The amine curing agent may include, for example, an aliphatic polyamine, an alicyclic polyamine, and an aromatic polyamine. Examples of the aliphatic polyamine may include ethylenediamine, diethylenetriamine, triethylenetetramine, tetraethylenepentamine, dipropylenediamine, diethylaminopropylamine, hexamethylenediamine, and polypropylenetriamine. As examples of the alicyclic polyamine, there may be mentioned menthenediamine, isophoronediamine, bis(4-amino-3-methyldicyclohexyl)methane, diaminodicyclohexylmethane, bis(aminomethyl)cyclohexane, N-aminoethylpiperazine, and 3,9-bis(3-aminopropyl)-3,4,8,10-tetraoxaspiro[5.5]undecane. Examples of the aromatic polyamine may include m-phenylenediamine, p-phenylenediamine, tolylene-2,4-diamine, tolylene-2,6-diamine, mesitylene-2,4-diamine, 3,5-diethyltolylene-2,4-diamine, 3,5-diethyltolylene-2,6-diamine, biphenylenediamine, 4,4-diaminodiphenylmethane, 2,5-naphthylenediamine, and 2,6-naphthylenediamine. These amine curing agents may be used alone or in combination. Widely used among these amine curing agents are, for example, the aliphatic polyamine (such as ethylenediamine, diethylenetriamine, triethylenediamine, tetraethylenepentamine, diethylaminopropylamine, or hexamethylenediamine), the alicyclic polyamine (such as menthenediamine or isophoronediamine), and the aromatic polyamine (such as xylenediamine or m-phenylenediamine).

Among these curing agents, the cationic polymerization initiator (the acid generator) is preferred in order to promote the polymerization and improve the hardness of the cured product.

The ratio of the curing agent can appropriately be selected according to the species of the first to third polymerizable compounds or the curing agent or other conditions. For example, the ratio of the curing agent relative to 100 parts by weight of the total amount of the polymerizable compounds (the total amount of the first to third polymerizable compounds) may be selected from a range of about 0.01 to 200 parts by weight (e.g., about 0.1 to 150 parts by weight).

The ratio of the cationic polymerization initiator relative to 100 parts by weight of the total amount of the polymerizable compounds (the total amount of the first to third polymerizable compounds) may be selected from a range of about 0.01 to 10 parts by weight, and is, for example, about 0.1 to 5 parts by weight, preferably about 0.5 to 5 parts by weight, and more preferably about 1 to 3 parts by weight (particularly about 1.5 to 2.5 parts by weight). An excessively small ratio of the cationic polymerization initiator may decelerate the progress of the curing reaction, resulting in a low hardness of the cured product. An excessively large ratio of the cationic polymerization initiator may decrease the storage stability of the composition or may cause the coloration of the cured product.

The ratio of the conventional curing agent such as the amine curing agent relative to 100 parts by weight of the polymerizable compound(s) (for example, the epoxy compound (A)) may, for example, be about 50 to 200 parts by weight, and preferably about 80 to 150 parts by weight.

[Conventional Additive]

The curable composition may contain any conventional additive that does not damage the effects of the present invention, including the adhesion improvement. The conventional additive may include, for example, a sensitizer (e.g., an acridine compound, a benzoflavin compound, a perylene compound, an anthracene compound, a thioxanthone compound, and a laser dye compound), a sensitizer aid, a curing accelerator (e.g., an imidazole compound, an alkali metal or alkaline earth metal alkoxide, a phosphine compound, an amide compound, a Lewis acid complex compound, a sulfur compound, a boron compound, and a condensable organic metal compound), a filler (e.g., an inorganic filler such as titanium oxide or alumina), a stabilizer (e.g., an antioxidant, an ultraviolet absorber, a light stabilizer, and a heat stabilizer), a plasticizer, a lubricant, an antifoaming agent, an antistatic agent, a flame retardant, and a coloring agent (such as a pigment or a dye). These additives may be used alone or in combination. The total ratio of these additives relative to 100 parts by weight of the total amount of the polymerizable compounds (the total amount of the first to third polymerizable compounds) is about not more than 100 parts by weight, for example, about not more than 30 parts by weight (e.g., about 0.01 to 20 parts by weight) and preferably about not more than 10 parts by weight (e.g., about 0.1 to 5 parts by weight).

The curable composition can be prepared by mixing or dispersing the epoxy compound (A) and the leveling agent (C), and if necessary, the hydroxy-group-containing polymerizable compound (B), the solvent (D), and other components such as the curing agent, in a conventional manner.

[Automotive Part Provided with Cured Layer]

(Processes for Producing Cured Layer and Automotive Part)

The cured layer (or cured product) can be formed through a step of curing the curable composition. The curable composition may be cured (or hardened) by irradiation with an active energy ray, by heating, or by combination of these methods, depending on the species of the curing agent or other conditions. Among these curing methods, the irradiation with an active energy ray is carried out in many embodiments.

As the active energy ray, heat and/or a light energy ray may be used. In particular, the irradiation with the light energy ray is useful. As the light energy ray, there may be used a radioactive ray (such as gamma ray or X-ray), an ultraviolet ray, a visible ray, an electron beam (EB), or other rays. The light energy ray usually includes an ultraviolet ray or an electron beam. In particular, for an application which requires a high weather resistance, the electron beam irradiation may be used because of polymerization without any curing agent.

For the ultraviolet ray, a light source may include, for example, a Deep UV lamp, a low-pressure mercury lamp, a medium-pressure mercury lamp, a high-pressure mercury lamp, a superhigh-pressure mercury lamp, a halogen lamp, a metal halide lamp, an arc lamp, an excimer lamp, a laser light source (a light source, e.g., a gas laser such as a helium-cadmium laser or an excimer laser, a solid-state laser such as a YAG laser, a semiconductor laser, and a liquid laser such as a dye laser), and a high-frequency induction ultraviolet generator. The quantity of the irradiation light (the irradiation energy or the integral of light), which depends on the thickness of the coat layer, may be, for example, about 10 to 10000 mJ/cm² (for example, about 50 to 7000 mJ/cm2), preferably about 70 to 5000 mJ/cm², and more preferably about 100 to 1000 mJ/cm². In order to improve the adhesion to a two- or three-dimensional shaped product, the quantity of light or the irradiation time may be increased. The quantity of the irradiation light may be, for example, about 300 to 10000 mJ/cm² (particularly about 400 to 3000 mJ/cm2).

For the electron beam, an exposure source (e.g., an electron beam irradiation apparatus) can be used for the electron beam irradiation. The radiation dose (dose), which depends on the thickness of the coat layer, is, for example, about 1 to 200 kGy (kilogray), preferably about 5 to 150 kGy, and more preferably about 10 to 100 kGy (particularly about 20 to 80 kGy). The acceleration voltage is, for example, about 10 to 1000 kV, preferably about 50 to 500 kV, and more preferably about 100 to 300 kV.

The irradiation with the active energy ray (in particular, the electron beam) may optionally be conducted in an atmosphere of an inactive gas (for example, nitrogen gas, argon gas, and helium gas).

After the curing by the active energy ray, the cured product may be heat-treated (annealed or aged). In the aging treatment, the heating temperature is, for example, about 30 to 250° C., preferably about 50 to 220° C., and more preferably about 60 to 200° C. (particularly about 120 to 160° C.). The heating time is, for example, about 10 minutes to 10 hours, preferably about 30 minutes to 5 hours, and more preferably 1 to 3 hours. The aging treatment may be carried out by gradually raising the temperature.

In a case where the curable resin composition is thermally cured by using a thermal cationic polymerization initiator (or thermal acid generator), the heating temperature is, for example, about 30 to 200° C., preferably about 50 to 190° C., and more preferably about 60 to 180° C. The heating time may be, for example, about 10 minutes to 6 hours and preferably 1 to 3 hours.

In the curing step, curing by the active energy ray such as an ultraviolet ray is preferred in view of applicability to various substrates (or supports).

Since thus obtained cured product or cured layer has an excellent adhesion, the cured product or cured layer allows adhesion (bonding or adherence) to the substrate, such as a shaped product, with a strong adhesive force without interposition of a primer layer. Thus, in an embodiment of the present invention, an automotive part (or composite shaped product) in which the cured layer and the substrate (or a substrate for an automobile) are bonded or adhered with a high adhesive force can be prepared. For example, such an automotive part may be prepared through applying the curable composition on a surface of the substrate to form a coat layer (or coating layer) and curing the coat layer.

The applying method may include, but should not be limited to, a conventional method, for example, roll coating, air knife coating, blade coating, rod coating, reverse coating, bar coating, comma coating, die coating, gravure coating, screen coating, spraying, and spinner coating. Widely used among these methods are, for example, blade coating, bar coating, and gravure coating.

The coat layer obtained by such a method may be dried by heating (or may be preheated) prior to the curing treatment. The preheating temperature is, for example, about 40 to 150° C., preferably about 50 to 120° C., and more preferably about 60 to 100° C. (particularly about 70 to 90° C.). The preheating time may be not shorter than 10 seconds (e.g., about 10 seconds to 10 minutes), preferably not shorter than 20 seconds (e.g., about 20 seconds to 5 minutes), and more preferably not shorter than 30 seconds (e.g., about 30 seconds to 2 minutes).

The cured product has an excellent adhesion to a wide range of substrates, and the material of the substrate or shaped product to be bonded to the cured product may include, but should not be limited to, either of an organic material or an inorganic material.

The organic material may include, for example, a resin material (e.g., an olefinic resin such as a polyethylene or a polypropylene, a styrenic resin such as an ABS resin, a vinyl-series resin such as a vinyl chloride resin, a (meth)acrylic resin such as a poly (methyl methacrylate), a polyester-series resin such as a poly(ethylene terephthalate) (PET), a polycarbonate-series resin, a polyamide-series resin, a cellulose derivative such as a cellulose ester or a cellulose ether, and a thermoplastic elastomer); a synthetic rubber material (such as an isoprene rubber or a butyl rubber); a foam of a resin or rubber (e.g., a polyurethane foam and a polychloroprene rubber foam); and a material derived from a plant or an animal (such as a wood, a pulp, a natural rubber, a leather, or a wool).

The inorganic material may include, for example, a ceramic material (such as a glass, a silicon, or a cement); a metal material [e.g., a metal simple substance (such as aluminum, iron, nickel, copper, zinc, chromium, or titanium) and an alloy containing these metals (such as an aluminum alloy or a steel (such as a stainless steel))].

The form (or shape) of the shaped product may include, but should not be limited to, for example, a one-dimensional form including a fiber form (such as a filamentous form, a rope form, or a wire form), a two-dimensional form including a board or plate form, a sheet form, a film form, a foil form, a fabric or cloth form (such as a woven fabric, a knitted fabric, or a nonwoven fabric), or a paper form (such as a woodfree paper, a glassine paper, a kraft paper, or a washi or traditional Japanese paper), and a three-dimensional form including a massive form, a block form, a rod form (such as a cylindrical form or a polygonal pillar form), or a tubular form.

Preferred among these substrates is a shaped product of an inorganic material, particularly, a shaped product of a metal material (for example, at least one metal material selected from the group consisting of an aluminum simple substance and an alloy containing aluminum, particularly an aluminum alloy). In a conventional manner, a primer treatment to the cured layer is necessary in advance to allow the cured layer to adhere to a shaped product of an inorganic material such as a ceramic material or a metal material. In an embodiment of the present invention, use of the curable composition allows effective adhesion of the substrate and the cured layer even in a case where the cured layer is directly bonded to the substrate without a primer treatment. This improves workability and allows simple and effective formation of an automotive part.

The substrate or the shaped product may optionally be subjected to a surface treatment, but which is not necessarily needed. The surface treatment may include, but should not be limited to, a conventional surface treatment, for example, a treatment for adjusting a surface profile, a treatment for adjusting a surface composition, and coating treatment. Examples of the treatment for adjusting a surface profile may include a blast treatment (such as a sandblasting treatment or a waterblasting treatment), an etching treatment (such as a plasma treatment, an electrolytic etching, or a chemical etching), a polishing treatment, and a shot peening. Examples of the treatment for adjusting a surface composition may include a conversion treatment (or chemical treatment), an anodization, an ion implantation, and a surface heat treatment (such as an induction hardening or a flame hardening). Examples of the coating treatment may include a plating treatment [e.g., a wet plating (such as an electroplating or a chemical plating), a dry plating or vapor deposition (such as a physical vapor deposition (PVD) or a chemical vapor deposition (CVD)), and a hot dipping (such as a hot dip galvanizing or a hot dip aluminizing)], a painting, a lining treatment (such as a resin lining or a glass lining), and a spraying treatment. These surface treatments may be used alone or in combination.

The substrate or shaped product has a surface (particularly, an area to be bonded to the cured layer) having a maximum height roughness Rz. The maximum height roughness Rz of the surface (particularly, the area to be bonded to the cured layer) is not limited to a specific value and may be selected from a range of, for example, about 0.1 to 100 μm (e.g., about 1 to 50 μm). In view of easiness of the adhesion improvement, the maximum height roughness Rz may be, for example, about 2 to 40 μm (e.g., about 3 to 30 μm), preferably about 3.5 to 20 μm (e.g., about 4 to 15 μm), more preferably about 4.5 to 12 μm (e.g., about 5 to 10 μm), and particularly about 5 to 8 μm. The maximum height roughness Rz can be measured in accordance with Japanese Industrial Standards (JIS) B0601 (2001). The surface having a maximum height roughness Rz within such a range has a significantly improved adhesion, and thus the maximum height roughness Rz within such a range is preferred.

Thus, of the surface of the substrate or shaped product, at least part of the area to be bonded to the cured layer may be roughened by the above-mentioned surface treatment or other means to adjust the Rz of the surface of the substrate. Specifically, in an embodiment of the present invention, the process for producing the composite shaped product may include surface-treating the substrate to adjust the Rz of the surface (particularly, that of an area to be bonded to the cured product) of the substrate prior to bonding to the cured product, in addition to the above-mentioned applying step and curing step.

The surface treatment for forming the roughened surface of the substrate or shaped product may include, but should not be limited to, for example, the surface treatments exemplified above. These surface treatments may be used alone or in combination. Among these surface treatments, a treatment for adjusting a surface profile is preferred, and a blast treatment (in particular, a sandblasting treatment) is more preferred. The surface roughening by a blast treatment allows easy adjustment of the Rz within the above-mentioned range in an extremely brief or simple manner, depending on the material or form of the shaped product, and achieves both high adhesion and high production efficiency. Further, the surface subjected to the blast treatment (in particular, a sandblasting treatment with alumina as an abrasive) appears to have an improved adhesion compared with surfaces subjected to other surface treatments, even in a case where the surface of the substrate or shaped product (in particular, an area to be bonded to the cured product) has the same level of the maximum height roughness Rz. Although the reason for this is not clear, the reason seems to be that a finely uneven structure formed by the blast treatment increases the surface area.

Representative examples of the material of abrasive grains (or abrasive) to be used in the blast treatment may include an inorganic substance, for example, a metal oxide (such as alumina or zirconia), a metal or an alloy (such as iron, aluminum, copper, stainless steel, or an aluminum alloy), a glass, silicon carbide, and sodium bicarbonate; and an organic substance, for example, a resin [e.g., a polyamide resin (such as a nylon), a polyester resin (such as an unsaturated polyester), a polycarbonate resin, a urea resin, and a melamine resin], and a plant (such as corncob, walnut shell, peach or apricot pit). Each of these materials may be used alone or in combination. In particular, from the productivity or other viewpoints, alumina is preferred.

(Characteristics of Automotive Part)

In an embodiment of the present invention, the cured layer in the automotive part has a high adhesion to the substrate without a primer layer or other layers. Moreover, the cured layer has not only an excellent appearance (or external appearance) and a high surface smoothness but also a high hardness, a high abrasion resistance, and excellent sliding properties. Thus, the automotive part can preferably be used as a sliding member or other members.

For the adhesion between the substrate and the cured layer in the automotive part, the number of square sections which remained without being peeled in the tape peel test described in the after-mentioned Examples may be, for example, not less than 30 (e.g., about 50 to 100), preferably not less than 70, more preferably not less than 90, and particularly 100.

Moreover, for the adhesion between the substrate and the cured layer in the automotive part, the peel strength in the Surface and Interfacial Cutting Analysis System (SAICAS) test described in the after-mentioned Example may be selected from a range of, for example, not less than 0.05 kN/m (e.g., about 0.1 to 3 kN/m) and may be, for example, not less than 0.2 kN/m (e.g., about 0.3 to 2.5 kN/m), preferably not less than 0.5 kN/m (e.g., about 0.7 to 2 kN/m), more preferably not less than 0.8 kN/m (e.g., about 0.9 to 1.8 kN/m), and particularly not less than 1 kN/m (e.g., about 1.1 to 1.6 kN/m).

The arithmetic average roughness Ra of the surface of the cured layer can be measured in accordance with JIS B0601 (2001). For example, the arithmetic average roughness Ra may be not more than 0.2 μm (e.g., about 0.001 to 0.18 μm), preferably not more than 0.15 μm (e.g., about 0.01 to 0.12 μm), and more preferably not more than 0.1 μm (e.g., about 0.02 to 0.08 μm). Too large an arithmetic average roughness Ra may reduce the surface smoothness of the cured layer, decreasing the sliding properties of the cured layer.

The indentation hardness of the surface of the cured layer can be measured by the microhardness evaluation test described in the after-mentioned Examples. For example, the indentation hardness may be, for example, about 50 to 400 N/mm² (e.g., about 100 to 300 N/mm²), preferably about 110 to 260 N/mm² (e.g., about 120 to 230 N/mm²), and more preferably about 140 to 200 N/mm² (e.g., about 150 to 180 N/mm²). Too low an indentation hardness may have a difficulty in maintaining the abrasion resistance for a long period of time.

The elastic modulus of the surface of the cured layer can be measured by the microhardness evaluation test described in the after-mentioned Examples. For example, the elastic modulus may be about 2000 to 5000 N/mm² (e.g., about 2500 to 4500 N/mm²), preferably about 3000 to 4000 N/mm² (e.g., about 3200 to 3800 N/mm²), and more preferably about 3400 to 3600 N/mm²

The elastic-plastic ratio of the surface of the cured layer can be measured by the microhardness evaluation test described in the after-mentioned Examples. For example, the elastic-plastic ratio may be, for example, about 10 to 45% (e.g., about 15 to 40%) and preferably about 20 to 35% (e.g., about 25 to 30%). The elastic-plastic ratio is a ratio of the amount of deformation recovered under unloading relative to the amount of deformation under loading and is a parameter determined from a loading-unloading curve. A larger value of the elastic-plastic ratio indicates a stronger elastic behavior (a strength force to return to the original even under loading).

The cured layer in the automotive part may have any average thickness that can suitably be selected according to purposes and that is not limited to a specific one. In a practical embodiment, the automotive part has the cured layer bonded or adhering to at least a partial area of the surface of the substrate or shaped product. Thus, the cured layer may have an average thickness of, for example, not less than 1 μm (e.g., about 1 to 100 μm), preferably about 5 to 80 μm, and more preferably about 10 to 50 μm (e.g., about 15 to 25 μm). Too small an average thickness may reduce the sliding properties and the rigidity. The average thickness can be, for example, determined as an average thickness value of any 10 points measured by an optical thickness meter.

(Representative Automotive Parts)

The automotive part may be utilized as a part which requires not only adhesion but also heat resistance, sliding properties, and weather resistance for an internal combustion. Examples of the automotive part may include an engine part, e.g., a coating member of a piston skirt; a sliding part such as a cam bearing, a crank bearing, or a connection rod bearing; a shaft part such as a camshaft or a crankshaft; a valve-gear sliding member such as a roller rocker, a rocker arm, a hydraulic lash adjuster, or a valve lifter; a chain-driven sliding part such as a chain guide, a chain damper, or a chain slipper; an engine auxiliary part such as a bearing portion of a vane or trochoid oil pump or a bearing portion of an alternator; or other transmission bearing parts.

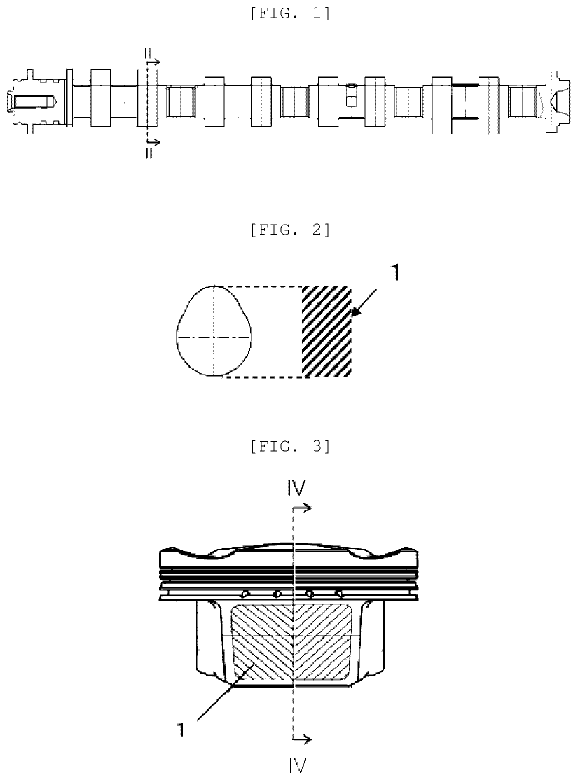

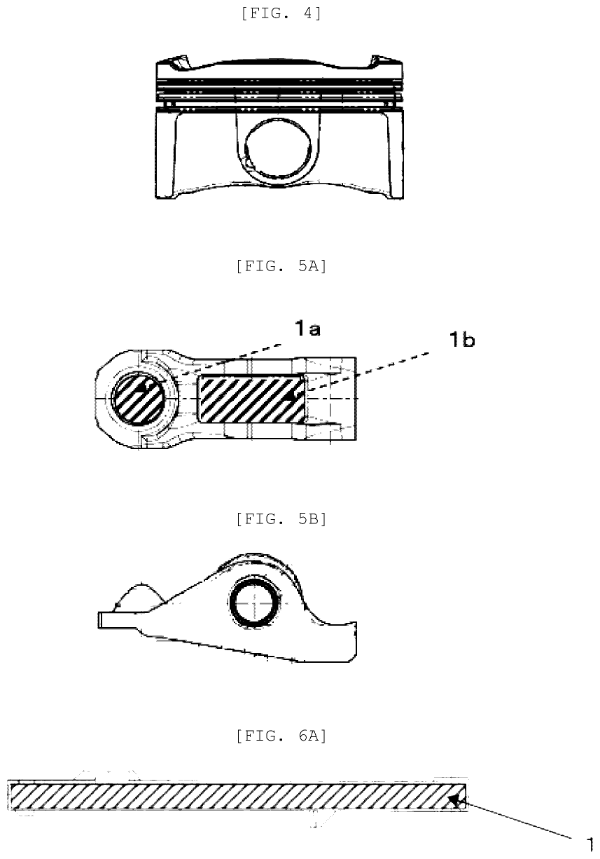

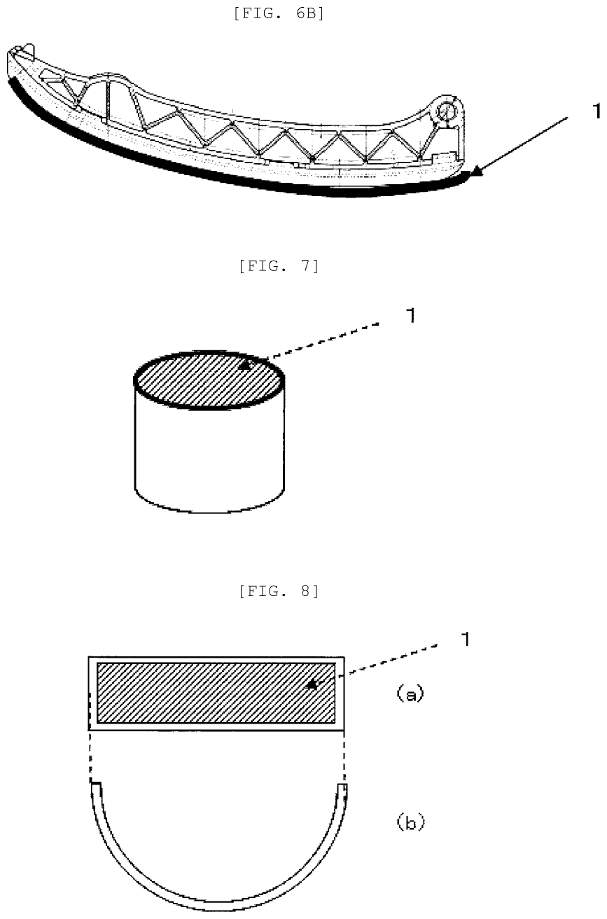

The cured layer is formed (or laminated or covered) on the surface of the substrate. The cured layer may be formed on the whole surface of the substrate or may be formed on a partial area of the surface of the substrate. In embodiments of the present invention as shown in FIGS. 1 to 8, the automotive part has the cured layer on a partial area of the substrate. FIGS. 1 and 2 are a schematic view of an example cam nose portion having a cured layer and a cross-sectional view taken along line II-II in FIG. 1, respectively. In FIG. 1, each of projections regularly arranged along an axial direction has a cured layer 1 on a surface thereof. FIGS. 3 and 4 are a schematic view of an example piston skirt portion having a cured layer and a cross-sectional view taken along line IV-IV in FIG. 3, respectively. The piston skirt portion has a cured layer 1 on a side face thereof. FIG. 5A is a schematic view of an example roller rocker portion having a cured layer. FIG. 5B is a side view of FIG. 5A. The roller portion has a cured layer 1a thereon, and the arm portion has a cured layer 1b thereon. FIG. 6A is a schematic view of an example chain damper portion having a cured layer. FIG. 6B is a partial cross-sectional view of FIG. 6A. The chain damper portion has an exterior portion having a cured layer 1 thereon. FIG. 7 is a schematic view of an example valve lifter portion having a cured layer. The valve lifter portion has a cured layer 1 on an upper surface thereof. FIG. 8 is a schematic view of an example cam and crank bearing portion having a cured layer. The crank bearing portion has a cured layer 1 on a surface thereof. In these embodiments, each portion on which the corresponding cured layer is disposed is a nonlimiting example.

### EXAMPLES

The following examples are intended to describe this invention in further detail and should by no means be interpreted as defining the scope of the invention. Materials and evaluation methods used in Examples and Comparative Examples are shown below.

[Materials]

(Substrate)

Aluminum alloy ADC12: #600 polish finishing, size 60 mm×60 mm×2 mm, arithmetic average roughness Ra=0.4566 μm, maximum height roughness Rz=4.0412 μm, a custom-made article manufactured by Nippon Testpanel Co., Ltd.

(Polymerizable Compounds)

Alicyclic epoxy compound 1: 3,4,3′,4′-Diepoxybicyclohexyl

Alicyclic epoxy compound 2: 3,4-Epoxycyclohexylmethyl (3,4-epoxy)cyclohexanecarboxylate, “CELLOXIDE 2021P” manufactured by Daicel Corporation

1,4-BDGE: 1,4-Butanediol diglycidyl ether

OXT-101: 3-Ethyl-3-hydroxymethyloxetane, “ARON OXETANE OXT-101” manufactured by TOAGOSEI CO., LTD.

HBVE: 4-Hydroxybutyl vinyl ether

ISB-DVE: Isosorbide divinyl ether, “ISB-DVE” manufactured by Daicel Corporation

(Polymerization Initiators)

CPI-100P: Solution of triarylsulfonium hexafluorophosphate in propylene carbonate, “CPI-100P” manufactured by San-Apro Ltd.

SI-100L: “SAN-AID SI-100L” manufactured by Sanshin Chemical Industry Co., Ltd.

(Leveling Agents)

Leveling agent 1: Solution of hydroxy-group-containing polyether-modified polydimethylsiloxane [solvent: methoxypropanol, nonvolatile matter (10 minutes, 150° C.): 25% by weight, hydroxyl value (effective component): 29 mgKOH/g], “BYK-SILCLEAN 3720” manufactured by BYK Japan KK

Leveling agent 2: Solution of hydroxy-group-containing polyester-modified polydimethylsiloxane [solvent: xylene/alkylbenzene/cyclohexanone/monophenyl glycol (weight ratio: 75/11/7/7), nonvolatile matter (10 minutes, 150° C.): 25% by weight, hydroxyl value (solid content): 35 mgKOH/g], “BYK-370” manufactured by BYK Japan KK

Leveling agent 3: Solution of hydroxy-group-containing silicone-modified polyacrylate [solvent: methoxypropyl acetate, nonvolatile matter (30 minutes, 150° C.): 25% by weight, hydroxyl value (effective component): about 30 mgKOH/g], “BYK-SILCLEAN 3700” manufactured by BYK Japan KK

Leveling agent 4: Hydroxy-group-containing polyether-modified polydimethylsiloxane [hydroxyl value (solid content): about 45 mgKOH/g], “BYK-377” manufactured by BYK Japan KK

Leveling agent 5: Solution of polyester-modified polymethylalkylsiloxane [solvent: γ-butyrolactone/alkylbenzene (weight ratio: 1/1), more specifically γ-butyrolactone/solvent naphtha/1,2,4-trimethylbenzene/xylene (weight ratio: (20 to 30)/(10 to 20)/6.84/(0.1 to 1), solvent in total: 48% by weight of whole solution, nonvolatile matter (60 minutes, 105° C.): 52% by weight], “BYK-325” manufactured by BYK Japan KK

Leveling agent 6: Solution of polyether-modified polymethylalkylsiloxane [solvent: white spirit/methoxypropyl acetate (weight ratio: 9/1), nonvolatile matter (60 minutes, 105° C.): 52% by weight], “BYK-320” manufactured by BYK Japan KK

Leveling agent 7: Solution of polyester-modified polydimethylsiloxane [solvent: methoxypropyl acetate, nonvolatile matter (10 minutes, 150° C.): 15% by weight], “BYK-313” manufactured by BYK Japan KK

Leveling agent 8: Aralkyl-modified polymethylalkylsiloxane, “BYK-322” manufactured by BYK Japan KK

Leveling agent 9: Acrylic copolymer, “BYK-350” manufactured by BYK Japan KK

[Evaluation Methods]

(Tape Peel Test)

Each of composite shaped products obtained in the following examples was simply evaluated for the adhesion between a substrate and a coated layer as follows. Eleven parallel cuts spaced 2 mm were introduced to the coated layer. The process was intersectingly repeated at an angle of 900 so that a lattice pattern was formed, consisting of 100 (10×10) single square sections. A cellulose adhesive tape (Nichiban Co., Ltd., CELLOTAPE™) was applied over the pattern and pulled off rapidly. Thereafter, among the 100 square sections, the number of square sections of which the coated layer remained the area not less than 80% was counted.

(SAICAS (Surface and Interfacial Cutting Analysis System) Test)

Each of composite shaped products obtained in the following examples was evaluated for the interfacial peel strength [kN/m] by SAICAS test, which can quantitatively evaluate the adhesion (particularly the adhesion in an area having a relatively high peel strength) compared with the tape peel test. The SAICAS test was carried out using a surface and interfacial cutting analysis system (“DN-GS” manufactured by DAIPLA WINTES CO., LTD.) under the following conditions.

Measurement Conditions

Measurement mode: low-speed mode

Cutter: borazon cutter (width of cutter blade: 1 mm, rake angle: 20°, clearance angle: 10°)

Vertical-displacement measurement point: cutter holder

Horizontal speed: 2 μm/sec.

Vertical speed: 0.1 μm/sec.

Cutting restriction: manual (turn ON when reached the interface between cured layer (coating layer) and substrate or the interface between cured layer (coating layer) and primer layer

(Appearance Evaluation)

The coated layer (or cured layer) was evaluated for the appearance on the basis of the following criteria.

A: The coating film (hardened layer) is uniform and there is no repelling mark of the coating film.

B: The coating film has a trace of unevenness or tear.

(Smoothness Evaluation)

In accordance with JIS B0601 (2001), the arithmetic average roughness Ra [μm] of the surface of the coated layer (cured layer) was measured using a microfigure measuring instrument (“ET4000A” manufactured by Kosaka Laboratory Ltd.).

(Abrasion Test)

An abrasion test was carried out under the following conditions, and then the presence or absence of sliding marks and the maximum depth value of sliding marks were observed using a microfigure measuring instrument (“ET4000A” manufactured by Kosaka Laboratory Ltd.).

Abrasion Test Conditions

Load: 2.5[N], 5[N], and 10[N]

Environment: immersion in Toyota Castle Oil 0W-30

Temperature: 80° C.

Mating material: SUJ2 hard ball (ϕ10 mm)

Reciprocating speed: 1.8 Hz

Reciprocating width: 10 mm

Time: 5 minutes

(Microhardness Evaluation)

The indentation hardness [N/mm²], elastic modulus [N/mm²], and elastic-plastic ratio [%] were measured using a microhardness tester (“ENT-2100” manufactured by ELIONIX INC.) under the following conditions, and the average value of 9 measurements (n=9) was determined.

Measurement Conditions

Measurement mode: load-unload mode

Surface detection: slope (2.0)

Load curve: 5 mN over 10 seconds (linear)

Creep: 5 mN for 10 seconds

Unload curve: 0 mN over 10 seconds (linear)

Indenter: Berkovich indenter

### Comparative Example 1, Examples 1 to 20, Reference Example 1

For each example, the components shown in Table 1 were mixed at the proportion shown in Table 1 to prepare a curable composition. An aluminum alloy ADC12 as a substrate was degreased with acetone. Without application of a primer on the degreased substrate, the curable composition was applied on the substrate with the use of a wire bar #10, and was then prebaked at 80° C. for one minute. The prebaked product was ultraviolet-treated at a cumulative quantity of 1600 mJ/cm² by irradiation with an ultraviolet ray using a belt-conveyor high-pressure mercury lamp (“UVC-02516S1” manufactured by USHIO INC.) at a lamp outlet of 120 W and a conveyor speed of 5.5 m/min. Finally, the UV-treated product was heat-treated (aged) at 80° C. for one hour and then 150° C. for one hour to cure the coating layer of the curable composition, giving a composite shaped product (a coated aluminum alloy plate). Table 2 shows the evaluation of the resulting composite shaped products.

### Comparative Example 2

An aluminum alloy ADC12 as a substrate was degreased with acetone. A polyamideimide (PAI) (“MOLYKOTE D-7409” manufactured by Dow Corning Toray Co., Ltd.) as a primer was applied on the degreased substrate with the use of a wire bar #3, and was then prebaked at 80° C. for 15 minutes and was baked at 200° C. for 60 minutes. A composite shaped product (coated aluminum alloy plate) having the polyamideimide layer formed on the substrate was produced. Table 2 shows the evaluation of the resulting composite shaped product.

TABLE 1

| | Composition (parts by weight) | | | | | | | | | | | | | | |
|---|---|---|---|---|---|---|---|---|---|---|---|---|---|---|---|
| | Alicyclic | 1,4- | OXT- | | Leveling agent | | | | | | | | | ISB- | CPI- |
| | epoxy 1 | BDGE | 101 | HBVE | 1 | 2 | 3 | 4 | 5 | 6 | 7 | 8 | 9 | DVE | 100P |
| Com. Ex. 1 | 100 | | | | 1 | | | | | | | | | | 2 |
| Ex. 1 | 80 | 20 | | | 1 | | | | | | | | | | 2 |
| Ex. 2 | 80 | 20 | | | | 0.5 | | | | | | | | | 2 |
| Ex. 3 | 70 | 20 | 10 | | 1 | | | | | | | | | | 2 |
| Ex. 4 | 60 | 20 | 20 | | 1 | | | | | | | | | | 2 |
| Ex. 5 | 50 | 20 | 30 | | 1 | | | | | | | | | | 2 |
| Ex. 6 | 60 | 20 | 20 | | | 0.5 | | | | | | | | | 2 |
| Ex. 7 | 50 | 20 | 30 | | | 0.5 | | | | | | | | | 2 |
| Ref. Ex. 1 | 40 | 20 | 30 | 10 | | | | | | | | | | | 2 |
| Ex. 8 | 40 | 20 | 30 | 10 | 1 | | | | | | | | | | 2 |
| Ex. 9 | 30 | 20 | 30 | 10 | 1 | | | | | | | | | 10 | 2 |
| Ex. 10 | 40 | 20 | 30 | 10 | 0.5 | | | | | | | | | | 2 |
| Ex. 11 | 40 | 20 | 30 | 10 | | 0.5 | | | | | | | | | 2 |
| Ex. 12 | 40 | 20 | 30 | 10 | | | 0.5 | | | | | | | | 2 |
| Ex. 13 | 40 | 20 | 30 | 10 | | | | 0.5 | | | | | | | 2 |
| Ex. 14 | 40 | 20 | 30 | 10 | | | | | 0.5 | | | | | | 2 |
| Ex. 15 | 60 | 20 | 10 | 10 | | | | | 0.5 | | | | | | 2 |
| Ex. 16 | 60 | 5 | 30 | 5 | | | | | 0.5 | | | | | | 2 |
| Ex. 17 | 40 | 20 | 30 | 10 | | | | | | 0.5 | | | | | 2 |
| Ex. 18 | 40 | 20 | 30 | 10 | | | | | | | 0.5 | | | | 2 |
| Ex. 19 | 40 | 20 | 30 | 10 | | | | | | | | 0.5 | | | 2 |
| Ex. 20 | 40 | 20 | 30 | 10 | | | | | | | | | 0.5 | | 2 |

TABLE 2

| | | SA\|CAS | | | | | |
|---|---|---|---|---|---|---|---|
| | Tape peel | Peel strength | Abrasion test | | | | Ra |
| | Cross cut | [kN/m] | 2.5N | 5N | 10N | Appearance | [μm] |
| Com. Ex. 1 | 20/100 | <0.05 | | | | A | |
| Ex. 1 | 80/100 | <0.05 | | | | A | |
| Ex. 2 | 100/100 | <0.05 | | | | A | |
| Ex. 3 | 80/100 | <0.05 | | | | A | |
| Ex. 4 | 90/100 | <0.05 | | | | A | |
| Ex. 5 | 100/100 | <0.05 | | | | A | |
| Ex. 6 | 95/100 | <0.05 | | | | A | |
| Ex. 7 | 100/100 | <0.05 | | | | A | |
| Ref. Ex. 1 | 90/100 | | | | | B | 0.245 |
| Ex. 8 | 100/100 | <0.05 | | | | A | |
| Ex. 9 | 100/100 | <0.05 | | | | A | |
| Ex. 10 | 100/100 | <0.05 | | | | A | 0.060 |
| Ex. 11 | 100/100 | 0.14 | | | | A | 0.073 |
| Ex. 12 | 98/100 | | | | | B | 0.041 |
| Ex. 13 | 100/100 | 0.28 | | | | A | 0.039 |
| Ex. 14 | 100/100 | 0.39 | No marks | No marks | No marks | A | 0.047 |
| Ex. 15 | 100/100 | <0.05 | No marks | No marks | Sliding marks | A | |
| | | | | | (<0.5 μm) | | |
| Ex. 16 | 100/100 | <0.05 | No marks | No marks | Sliding marks | A | |
| | | | | | (<0.5 μm) | | |
| Ex. 17 | 79/100 | | | | | B | 0.120 |
| Ex. 18 | 86/100 | | | | | B | 0.090 |
| Ex. 19 | 79/100 | | | | | B | 1.032 |
| Ex. 20 | 49/100 | | | | | B | 0.088 |
| Com. Ex. 2 | 100/100 | | No marks | No marks | Abrasion to | | |
| | | | | | substrate | | |

As apparent from Table 2, Comparative Example 1, which was the conventional curable composition and had no applied primer, had a low adhesion as shown in the result of the tape peel test of 20/100. In contrast, Examples, even which had no applied primer, showed the results of the tape peel test about 2.5 times or more as high as the result in Comparative Example 1. Incidentally, Reference Example 1, which contained no leveling agent, showed an improved adhesion compared with Comparative Example 1, while Reference Example 1 had not only a poor appearance but also a large Ra, thus being unsuitable as a sliding member.

Examples 10 to 14 and 17 to 20, which had the same composition of the curable composition and were different in kind of leveling agent, were compared. For the tape peel test, Example 10 to 13 that used a hydroxy-group-containing leveling agent (particularly, Examples 10, 11, and 13 that used a leveling agent mainly containing a silicone unit) and Example 14 that used a leveling agent containing a high-boiling solvent (particularly, γ-butyrolactone) had an excellent adhesion. Among them, Examples 11 and 13 that used a leveling agent having a slightly high hydroxyl value and Example 14 that used a leveling agent containing a high-boiling solvent showed a high adhesion also in the SAICAS test. Moreover, Examples 10, 11, 13, and 14 had an excellent appearance and a low Ra.

From Examples which used the same kind of a leveling agent (for example, Examples 14 to 16), it is presumed that too high a proportion of the alicyclic epoxy compound may reduce the adhesion or the abrasion resistance under a high-load environment.

### Comparative Example 3

The components shown in Table 3 were mixed at the proportion shown in Table 3 to prepare a curable composition. A composite shaped product was produced in the same manner as Comparative Example 1 except that a composite shaped product obtained in Comparative Example 2 [an aluminum alloy plate (with no blast treatment) having a polyamideimide layer (a primer layer)] was used as a substrate and that the resulting curable composition was applied on the primer layer of the composite shaped product. Table 4 shows the evaluation of the resulting composite shaped product.

### Comparative Example 4, Examples 21 to 27

For each example, a composite shaped product was produced as follows. The components shown in Table 3 were mixed at the proportion shown in Table 3 to prepare a curable composition. An aluminum alloy ADC12 was subjected to a sandblasting treatment (abrasive: alumina) so as to have a Rz of about 5 μm. The treated aluminum alloy plate had a Rz of 5.0347 μm and a Ra of 0.6961 μm. A composite shaped product was produced in the same manner as Comparative Example 1 except that the aluminum alloy plate was used as a substrate and that the resulting curable composition was applied on the sandblasting-treated surface of the aluminum alloy plate. Table 4 shows the evaluation of each composite shaped product.

### Example 28

The components shown in Table 3 were mixed at the proportion shown in Table 3 to prepare a curable composition. An aluminum alloy ADC12 was subjected to a sandblasting treatment so as to have a Rz of about 10 μm. The treated aluminum alloy plate had a Rz of 10.4378 μm and a Ra of 1.3561 μm. A composite shaped product was produced in the same manner as Comparative Example 1 except that the aluminum alloy plate was used as a substrate and that the resulting curable composition was applied on the sandblasting-treated surface of the aluminum alloy plate. Table 4 shows the evaluation of the resulting composite shaped product.

TABLE 3

| | Composition (parts by weight) | | | | | | | | | |
|---|---|---|---|---|---|---|---|---|---|---|
| | | Alicyclic | Alicyclic | 1,4- | OXT- | | Leveling agent | | | CPI- |
| | Substrate | epoxy 1 | epoxy 2 | BDGE | 101 | HBVE | 1 | 4 | 5 | 100P |
| Com. Ex. 3 | PAI coat (D-7409) | 100 | | | | | 1 | | | 2 |
| Com. Ex. 4 | Sandblasting treatment | 100 | | | | | | 0.5 | | 2 |
| | (Rz 5 μm) | | | | | | | | | |
| Ex. 21 | Sandblasting treatment | 60 | | 20 | 10 | 10 | | 0.5 | | 2 |
| | (Rz 5 μm) | | | | | | | | | |
| Ex. 22 | Sandblasting treatment | 40 | 10 | 20 | 30 | | | 0.5 | | 2 |
| | (Rz 5 μm) | | | | | | | | | |
| Ex. 23 | Sandblasting treatment | 40 | | 20 | 30 | 10 | | 0.5 | | 2 |
| | (Rz 5 μm) | | | | | | | | | |
| Ex. 24 | Sandblasting treatment | 40 | 20 | 5 | 30 | 5 | | 0.5 | | 2 |
| | (Rz 5 μm) | | | | | | | | | |
| Ex. 25 | Sandblasting treatment | 30 | 10 | 20 | 30 | 10 | | 0.5 | | 2 |
| | (Rz 5 μm) | | | | | | | | | |
| Ex. 26 | Sandblasting treatment | 60 | | 5 | 30 | 5 | | | 0.5 | 2 |
| | (Rz 5 μm) | | | | | | | | | |
| Ex. 27 | Sandblasting treatment | 40 | | 20 | 30 | 10 | | | 0.5 | 2 |
| | (Rz 5 μm) | | | | | | | | | |
| Ex. 28 | Sandblasting treatment | 40 | | 20 | 30 | 10 | | | 0.5 | 2 |
| | (Rz 10 μm) | | | | | | | | | |

TABLE 4

| | | | Microhardness | | | | | | |
|---|---|---|---|---|---|---|---|---|---|
| | | SA\|CAS | | | Elastic- | | | | |
| | Tape | Peel | Indentation | Elastic | plastic | | | | |
| | peel | strength | hardness | modulus | ratio | Abrasion test | | | |
| | Cross cut | [kN/m] | [N/mm²] | [N/mm²] | [%] | 2.5N | 5N | 10N | Appearance |
| Com. Ex. 3 | 100/100 | 1.29 | | | | Sliding marks | Sliding marks | Sliding marks | A |
| | | | | | | (<0.5 μm) | (<0.5 μm) | (<0.5 μm) | |
| Com. Ex. 4 | 82/100 | <0.05 | 413 | 5240 | 49.1 | No marks | No marks | No marks | |
| Ex. 21 | 100/100 | <0.05 | 247 | 3920 | 39.5 | No marks | No marks | No marks | A |
| Ex. 22 | 100/100 | 0.1 | 208 | 3950 | 33.1 | No marks | No marks | No marks | A |
| Ex. 23 | 100/100 | 1.11 | 160 | 3670 | 27.0 | No marks | No marks | No marks | A |
| Ex. 24 | 100/100 | 0.28 | 251 | 4420 | 34.4 | No marks | No marks | No marks | A |
| Ex. 25 | 100/100 | 1.42 | 115 | 3010 | 22.8 | No marks | No marks | No marks | A |
| Ex. 26 | 100/100 | <0.05 | | | | | | | A |
| Ex. 27 | 100/100 | 0.97 | 161 | 3510 | 28.0 | No marks | No marks | Sliding marks | A |
| | | | | | | | | (<0.5 μm) | |
| Ex. 28 | 100/100 | 0.87 | | | | | | | A |

As apparent from Table 4, Examples had an improved adhesion compared with Comparative Example 4. Moreover, all Examples have a high abrasion resistance, an excellent appearance, and a smooth surface of the cured layer.

Further, from the comparison of Example 13 with Example 23, the comparison of Example 14 with Example 27, or other comparisons, just an adjustment of the maximum height roughness Rz to about 5 μm by the blast treatment improved the adhesion (SAICAS test) to about 2.5 to 4 times. The aluminum substrate before the blast treatment had a Rz of about 4 μm, and thus it was found that even an extremely slight blast treatment significantly improved the adhesion. Example 28, in which the surface of the substrate had a maximum height roughness of Rz of 10 μm, had substantially the same adhesion as that in Example 27, in which the surface of the substrate had a maximum height roughness of 5 μm, where the same curable composition was applied in Examples 27 and 28.

Among these Examples, Examples 23, 25, and 27 had excellent adhesion, microhardness, abrasion resistance, appearance, and surface smoothness in a balanced manner. Among these Examples, Example 25 had a slightly low microhardness, and Example 27 had a slightly low abrasion resistance under a high load environment probably due to the influence of the structure or polarity of the leveling agent or other agents on the surface of the cured layer. Thus, in particular, Example 23 had the above-mentioned characteristics in an excellent balanced manner. Although Comparative Example 3 had a high adhesion, the necessity of the primer layer made the productivity low. In addition, Comparative Example 3 had a low abrasion resistance probably due to the softness of the primer layer.

Among Examples, Examples 23, 25, and 27 to 28 (preferably Examples 23, 25, and 27, particularly Example 23) have an excellent adhesion and are particularly suitable for an automotive part (in particular, a sliding member such as a piston skirt portion) which requires a high adhesion or other characteristics.

### Example 29

A composite shaped product was produced in the same manner as Example 13 except that 2 parts by weight of a thermal polymerization initiator or thermal acid generator (“SAN-AID SI-100L” manufactured by Sanshin Chemical Industry Co., Ltd.) was added instead of CPI-100P in a curable composition and that a thermal treatment at 80° C. for 15 minutes and then a thermal treatment at 150° C. for 2 hours were conducted instead of an ultraviolet treatment and an aging treatment. A smooth cured layer was obtained. The cured layer had an excellent appearance evaluated as grade “A” and obtained a high adhesion as shown in the result of the cross cut test of 100/100.

### INDUSTRIAL APPLICABILITY

In an embodiment of the present invention, the automotive part is effectively utilizable as, for example, an engine part, e.g., a coating member of a piston skirt; a sliding part such as a cam bearing, a crank bearing, or a connection rod bearing; a shaft part such as a camshaft or a crankshaft; a valve-gear sliding member such as a roller rocker, a rocker arm, a hydraulic lash adjuster, or a valve lifter; a chain-driven sliding part such as a chain guide, a chain damper, or a chain slipper; an engine auxiliary part such as a bearing portion of a vane or trochoid oil pump or a bearing portion of an alternator; or other transmission bearing parts.

### REFERENCE SIGNS LIST

1, 1a, 1b . . . Cured layer

1. An automotive part comprising a substrate and a cured layer bonded to the substrate, wherein the cured layer comprises a cured product of a curable composition containing:
(A) an epoxy compound containing (A1) a first epoxy compound having at least two alicyclic epoxy groups and (A2) a second epoxy compound represented by the following formula (3): 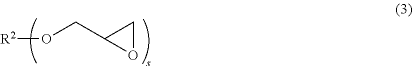
wherein s denotes an integer of not less than 2, R² represents a s-valent straight-chain or branched-chain saturated aliphatic hydrocarbon group, or a s-valent group in which two or more straight-chain or branched-chain saturated aliphatic hydrocarbon groups are coupled through ether bond(s); and
(C) a leveling agent.

2. The automotive part according to claim 1,
wherein the first epoxy compound (A1) contains a compound represented by the following formula (2): 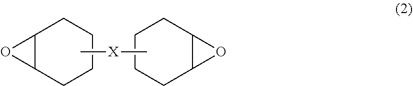
wherein X represents a single bond or a linkage group, and the cyclohexene oxide groups may have a substituent.

3. The automotive part according to claim 2, wherein the first epoxy compound (A1) contains a compound represented by the formula (2) in which X is a single bond, and the second epoxy compound (A2) contains a compound represented by the formula (3) in which the group R² has a total number of carbon atoms of 2 to 15 and the number s is 2 to 4.

4. The automotive part according to claim 1, wherein a weight ratio of the first epoxy compound (A1) relative to the second epoxy compound (A2) is 30/70 to 90/10 in the former/the latter.

5. The automotive part according to claim 1, wherein the curable composition further contains (B) a polymerizable compound having a hydroxy group and at least one polymerizable group selected from the group consisting of a vinyl ether group, an epoxy group, and an oxetane-ring-containing group.

6. The automotive part according to claim 5, wherein the polymerizable compound (B) contains (b1) a compound having one hydroxy group and one vinyl ether group and (b3) a compound having one hydroxy group and one oxetane-ring-containing group.

7. The automotive part according to claim 6, wherein a weight ratio of the epoxy compound (A) relative to the polymerizable compound (B) is 10/90 to 95/5 in the former/the latter, and a weight ratio of the compound (b3) relative to the compound (b1) is 10/90 to 95/5 in the compound (b3)/the compound (b1).

8. The automotive part according to claim 1, wherein the leveling agent (C) contains a hydroxy-group-containing leveling agent.

9. The automotive part according to claim 8, wherein the leveling agent (C) contains a silicone-series hydroxy-group-containing leveling agent.

10. The automotive part according to claim 8, wherein the leveling agent (C) contains a leveling agent having a hydroxyl value of 15 to 100 mgKOH/g.

11. The automotive part according to claim 1, wherein the curable composition further contains (D) a solvent at least containing (D1) a high-boiling solvent.

12. The automotive part according to claim 11, wherein the high-boiling solvent (D1) contains at least one high-boiling solvent selected from the group consisting of an aromatic hydrocarbon compound having an alkyl group and a cyclic ester compound.

13. The automotive part according to claim 1, wherein the substrate is a shaped product of an inorganic material.

14. The automotive part according to claim 13, wherein the inorganic material comprises a metal material.

15. The automotive part according to claim 1, wherein the substrate has a surface having an area with a maximum height roughness Rz of 1 to 50 μm, and the area is bonded to the cured layer.

16. The automotive part according to claim 1, which is a sliding member.

17. A process for producing an automotive part recited in claim 1, the process comprising: applying a curable composition recited in claim 1 to a substrate and curing the applied curable composition.

18. The process according to claim 17, wherein the substrate has a surface having an area with a maximum height roughness Rz of 1 to 50 μm.

19. The process according to claim 18, wherein the substrate is a blast-treated substrate.
